(19) United States
(12) Patent Application Publication
(10) Pub. No.: US 2026/0117457 A1
(43) Pub. Date: Apr. 30, 2026

(54) SILICONE - (METH)ACRYLATE COPOLYMER EMULSION AND PREPARATION THEREOF AND USE OF THE EMULSION TO IMPART OIL REPELLENCY TO TEXTILES

(71) Applicant: Dow Silicones Corporation, Midland, MI (US)

(72) Inventors: Anirudha Banerjee, Saginaw, MI (US); Devin Ferguson, Midland, MI (US); Matthew Jeletic, Freeland, MI (US); Douglas Hasso, Auburn, MI (US); Brian Macdonald, Midland, MI (US); Jodi Mecca, Midland, MI (US)

(21) Appl. No.: 19/158,486

(22) PCT Filed: Sep. 5, 2024
(86) PCT No.: PCT/US2024/045245

§ 371 Date: Aug. 21, 2025

Related U.S. Application Data
(60) Provisional application No. 63/593,716, filed on Oct. 27, 2023.
(60) Provisional application No. 63/674,322, filed on Jul. 23, 2024.

(51) Int. Cl. D06M 15/356; C09D 143/04; D06M 15/263; D06M 15/564; D06M 15/643

(52) U.S. Cl. CPC D06M 15/3568; C09D 143/04; D06M 15/263; D06M 15/564; D06M 15/6436; D06M 2200/11

(57) ABSTRACT

A textile treatment emulsion formulation includes a silicone-(meth)acrylate copolymer, a surfactant, water and a blocked isocyanate and method for its preparation are disclosed. The textile treatment emulsion may be used in a method including coating the emulsion formulation on a textile and heating the textile to dry the emulsion formulation. This method renders the textile oil repellent.

### CROSS-REFERENCE TO RELATED APPLICATIONS

This application claims priority under 35 USC § 119 (e) to U.S. Provisional Patent Application No. 63/593,716 filed on 27 Oct. 2023 and U.S. Provisional Patent Application No. 63/674,322 filed on 23 Jul. 2024. U.S. Provisional Patent Application Nos. 63/593,716 and 63/674,322 are hereby incorporated by reference.

### FIELD

An emulsion formulation suitable for treating a textile and methods for preparation and use thereof are provided. More specifically, the emulsion formulation includes a silicone-(meth)acrylate copolymer. The emulsion formulation is useful for treating textiles to impart durable oil repellency thereto.

### INTRODUCTION

Fluorinated materials have dominated the water and oil repellent textile coating market for many years. However, regulatory and customer pressures are contributing to an industry need for non-fluorocarbon-based textile treatments.

### SUMMARY

A silicone-(meth)acrylate copolymer comprises unit formula:

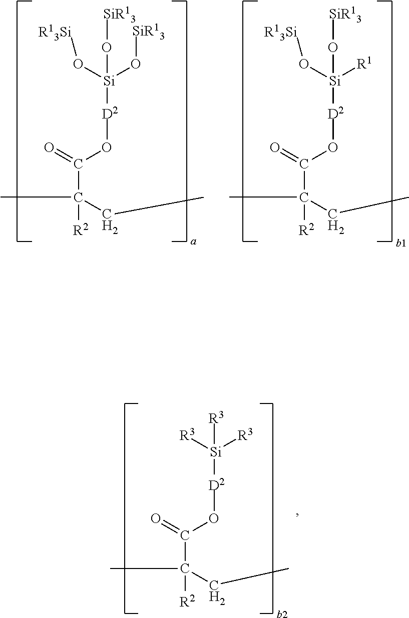

where each R¹ is an independently selected monovalent hydrocarbon group of 1 to 12 carbon atoms; each D² is an independently selected divalent hydrocarbon group of 2 to 12 carbon atoms; and each R² is independently selected from the group consisting of H and methyl; each R³ is a group of formula OSi(R⁴)₃; where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the silicone-(meth)acrylate co-macromonomer unit with subscript b2 has at least 5 silicon atoms; subscripts a, b1, and b2 represent weight fractions of units in the copolymer, and subscripts a, b1, and b2 have values such that 0.25<a≤1; and 0≤(b1+b2)<0.75. An emulsion formulation suitable for treating a textile comprises the silicone-(meth)acrylate copolymer, a surfactant, water, and a blocked isocyanate. Methods for preparation and use of the silicone-(meth)acrylate copolymer and the emulsion formulation are also provided.

### DETAILED DESCRIPTION

One skilled in the art would recognize that the silicone-(meth)acrylate copolymer (copolymer) introduced above may be prepared by radical polymerization, via a method as described below, and that this method would form a terminal moiety for the copolymer. The copolymer with the unit formula above further comprises a terminal moiety which may be derived from an initiator, a chain transfer agent, or both, as described, for example in Odian, George (2004). Principles of Polymerization (4th ed.). New York: Wiley-Interscience. ISBN 978-0-471-27400-1.

The copolymer may be prepared via a method comprising:
1) copolymerizing starting materials comprising
   (A) a silicone-(meth)acrylate macromonomer of formula

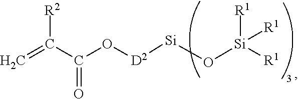

where each R¹ is an independently selected monovalent hydrocarbon group of 1 to 12 carbon atoms; D² is a divalent hydrocarbon group of 2 to 12 carbon atoms; and R² is selected from the group consisting of H and methyl;
optionally (B) a silicone-(meth)acrylate co-macromonomer, wherein (B) the silicone-(meth)acrylate co-macromonomer has a formula selected from the group consisting of formula (B-1), formula (B-2), and a combination of both formula (B-1) and formula (B-2), wherein
   formula (B-1) is

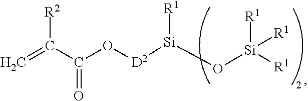

where each R¹ is an independently selected monovalent hydrocarbon group of 1 to 12 carbon atoms; D² is a divalent hydrocarbon group of 2 to 12 carbon atoms; and R² is selected from the group consisting of H and methyl;
formula (B-2) is

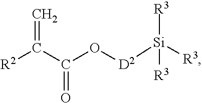

where R² is selected from the group consisting of H and methyl; D² is a divalent hydrocarbon group of 2 to 12 carbon atoms, and each R³ is a group of formula OSi(R⁴)₃; where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the silicone-(meth)acrylate co-macromonomer of formula (B-2) has at least 5 silicon atoms per molecule;
wherein starting material (A) is present in an amount of >25 weight % to 100 weight %, based on combined weights of starting materials (A) and (B); and wherein starting material (B) is present in an amount of 0 to <75 weight %, based on combined weights of starting materials (A) and (B); and wherein starting materials (A) and (B) are copolymerized in the presence of an additional starting material, wherein the additional starting material comprises (C) an initiator. The additional starting material used in step 1) may optionally further comprise one or more of (H) a chain transfer agent; (I) a manganese ion source; (J) a phenolic compound; and a chelating agent.

Step 1) of the method may comprise an emulsion polymerization reaction. The additional starting materials further comprise (D) a surfactant and (E) water. In step 1), the emulsion polymerization described above may comprise forming an emulsion comprising starting material (A) the silicone-(meth)acrylate macromonomer, (B) the silicone-(meth)acrylate co-macromonomer (when present), (D) the surfactant, (E) water, and optionally one or more of (H) the chain transfer agent, (I) the manganese ion source, and (J) the phenolic compound and thereafter adding (C) the initiator and copolymerizing. Without wishing to be bound by theory, it is thought that during processing to combine and emulsify (A) the silicone-(meth)acrylate macromonomer, (B) the silicone-(meth)acrylate co-macromonomer, (D) the surfactant, and (E) the water, and when present (H) the chain transfer agent, then starting materials (I) the manganese ion source and/or (J) the phenolic compound may inhibit formation of acrylic radicals that can impact the formation of the copolymer during copolymerization in step 1).

Step 1) of the method described above may comprise forming an emulsion comprising starting materials (A) the silicone-(meth)acrylate macromonomer, (B) the silicone-(meth)acrylate co-macromonomer, (C) the initiator, (D) the surfactant, and (E) the water, and optionally an additional starting material selected from the group consisting of (H) the chain transfer agent, (I) the manganese ion source, (J) the phenolic compound, and a combination of two or more thereof. These starting materials may be mixed under shear to form the aqueous emulsion. Mixing under shear may be performed by any convenient means for forming an aqueous emulsion, such as sonication and with subsequent microfluidization. Equipment for mixing under shear, such as sonicators, homogenizers, microfluidizers, and speedmixers are known in the art and are commercially available. Without wishing to be bound by theory, it is thought that mixing under shear may be used to obtain a submicron particle size in the emulsion. In step 1), starting materials comprising (A) the silicone-(meth)acrylate macromonomer, (B) the silicone-(meth)acrylate co-macromonomer, (C) the initiator (and when present (H) the chain transfer agent) copolymerize to form (F) the silicone-(meth)acrylate copolymer in the aqueous emulsion with starting materials (D) the surfactant and (E) the water, and optionally (I) manganese ion source and (J) the phenolic compound.

The method described herein may optionally further comprise one or more additional steps. For example, before step 1) the starting materials comprising (A) the silicone-(meth)acrylate macromonomer and (B) the silicone-(meth)acrylate co-macromonomer, and when present (H) the chain transfer agent may be combined under aerobic or anaerobic conditions, optionally with heating for extended times. For example, the starting materials comprising (A) the silicone-(meth)acrylate macromonomer and (B) the silicone-(meth)acrylate co-macromonomer, and when present one or more of (H) the chain transfer agent, (I) manganese ion source, and/or (J) the phenolic compound, may be emulsified with (D) the surfactant and (E) the water before adding (C) the initiator and copolymerizing in step 1). In step 1), combining the starting materials and copolymerizing in the method described above may be performed on a commercial scale under anaerobic or aerobic conditions optionally at elevated temperature, e.g., up to 100° C., alternatively 40° C. to 80° C., and alternatively 45° C. to 50° C. Copolymerizing may be performed in a batch process with a residence time of 15 minutes to 24 hours, alternatively 30 minutes to 12 hours, alternatively 40 minutes to 8 hours, and alternatively 40 minutes to 2 hours. For purposes of this application, aerobic or anaerobic conditions means that oxygen is not required to be present in the gas in the headspace of the reactor where copolymerizing takes place, or dissolved in the liquid where copolymerizing takes place. The balance of the gas in the headspace could be an inert gas such as nitrogen or argon.

Alternatively, the copolymer described above may be prepared by a method comprising dissolving one or more of the starting materials, such as (A) the silicone-(meth)acrylate macromonomer, (B) the silicone-(meth)acrylate co-macromonomer and optionally one or more of (H) the chain transfer agent, (I) the manganese ion source, and (J) the phenolic compound, in an organic solvent (such as a monohydric alcohol) and copolymerizing starting materials (A) the silicone-(meth)acrylate macromonomer and (B) the silicone-(meth)acrylate co-macromonomer, and when present (H) the chain transfer agent in a method such as that disclosed in U.S. Pat. No. 10,047,199 to Iimura et al. by varying appropriate starting materials and their amounts. The resulting copolymer may be solvent borne. All or a portion of the solvent may be removed by any convenient means, such as by stripping or distillation with heat and optionally reduced pressure. The resulting copolymer may be emulsified using (D) the surfactant and (E) the water.

Regardless of the method used to make the copolymer, e.g., either via emulsion polymerization or by emulsifying the solvent borne copolymer (after solvent removal), the product prepared in step 1) is an aqueous emulsion comprising (F) the silicone-(meth)acrylate copolymer, (D) the surfactant, and (E) the water. The aqueous emulsion may optionally further comprise (I) the manganese ion source and/or (J) the phenolic compound. This aqueous emulsion can be used to prepare the emulsion formulation useful for treating a textile. The method for preparing the emulsion formulation suitable for treating the textile comprises practicing step 1) as described above, thereby preparing the aqueous emulsion, and 2) combining the aqueous emulsion prepared in step 1) and an additional starting material comprising (G) a blocked isocyanate. Step 2) may optionally further comprise adding a further additional starting material, which may be selected from the group consisting of (K) a biocide, (L) additional water (which may be the same as starting material (E)), (M) a flame retardant, (N) a wrinkle reducing agent, (O) an antistatic agent, (P) a penetrating agent. (Q) an additive such as a softening agent, and a combination of two or more thereof. Step 2) of this method may optionally further comprise adding additional (D) surfactant.

Step 2) of the process described above for making the emulsion formulation may be performed by any convenient means, such as mixing using a jacketed vessel equipped with an agitator. Step 1) and step 2), and any optional and/or additional steps as described above may be performed sequentially in the same vessel. Alternatively, step 1) and step 2) may be performed in different equipment. Step 2) may be performed at RT or elevated temperature, e.g., up to 100° C., alternatively 40° C. to 80° C. Alternatively, heating may be performed in step 1), and step 2) may be performed at RT. Alternatively, step 2) may be performed at lower temperatures and elevated pressures, such as up to 5 atmospheres. The starting materials used in the method described above are further described below.

Starting material (A) used herein is a silicone-(meth)acrylate macromonomer. The silicone-(meth)acrylate macromonomer has formula (A-1):

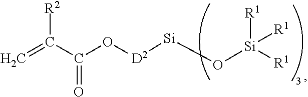

where each R¹ is an independently selected monovalent hydrocarbon group of 1 to 12 carbon atoms; D² is a divalent hydrocarbon group of 2 to 12 carbon atoms; and R² is selected from the group consisting of H and methyl.

In formula (A-1), each R¹ is an independently selected monovalent hydrocarbon group of 1 to 12 carbon atoms. The monovalent hydrocarbon group for R¹ may be an alkyl group, such as an alkyl group of 1 to 6 carbon atoms. Alternatively, the alkyl groups may have 1 to 3 carbon atoms, alternatively 1 to 2 carbon atoms. Alternatively, each R¹ group may be methyl.

In formula (A-1), D² is a divalent hydrocarbon group of 2 to 12 carbon atoms. Alternatively, D² may have 2 to 10, alternatively 3 to 5, and alternatively 3 carbon atoms. The divalent hydrocarbon group for D² may be exemplified by an alkylene group such as ethylene, propylene, or butylene. Alternatively, the divalent hydrocarbon group for D² may be propylene. Alternatively, D² may be linear, e.g., —(CH₂)₂— or —(CH₂)₃—. Alternatively, D² may be —(CH₂)₃—. Alternatively, when D² comprises —(CH₂)₃—, starting material (A) comprises formula (A-2):

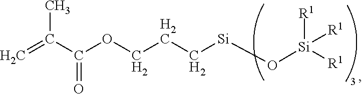

where R¹ is as described above.

Starting material (A) may comprise 3-(1,1,1,5,5,5-hexamethyl-3-((trimethylsilyl)oxy)trisiloxan-3-yl) propyl methacrylate of formula

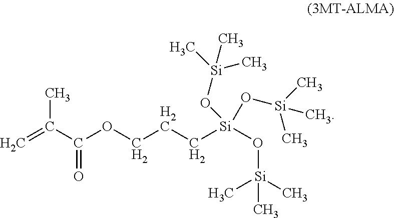 [SMILES: C=C(C)C(=O)OCCC[Si](O[Si](C)(C)C)(O[Si](C)(C)C)O[Si](C)(C)C]

Starting material (A) may be prepared by known methods, such as those disclosed in PCT Publication WO2020142388 and U.S. Pat. No. 6,420,504.

Starting material (B) is a silicone-(meth)acrylate co-macromonomer (co-macromonomer) that may optionally be copolymerized with (A) the silicone-(meth)acrylate macromonomer described above. Starting material (B), the co-macromonomer, may comprise formula (B-1), where formula (B-1) is

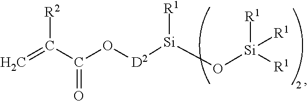

where each R¹ is an independently selected monovalent hydrocarbon group of 1 to 12 carbon atoms; D² is a divalent hydrocarbon group of 2 to 12 carbon atoms; and R² is selected from the group consisting of H and methyl, each as described and exemplified above for formula (A-1). Alternatively, when D² comprises —(CH₂)₃—, formula (B-1) may comprise:

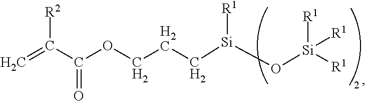

where R¹ and R² are as described above. Alternatively, formula (B-2) may comprise 3-(1,1,1,3,5,5,5-heptamethyltrisiloxan-3-yl) propyl methacrylate of formula

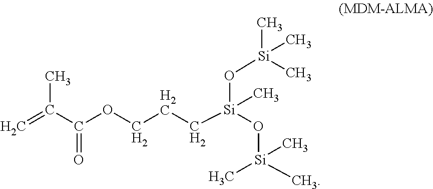 [SMILES: C=C(C)C(=O)OCCC[Si](C)(O[Si](C)(C)C)O[Si](C)(C)C]

Alternatively, in addition to, or instead of, formula (B-1) shown above, starting material (B) the co-macromonomer may comprise a silicone-(meth)acrylate co-macromonomer of formula (B-2):

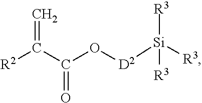

where D² is a divalent hydrocarbon group of 2 to 12 carbon atoms; and R² is selected from the group consisting of H and methyl, each as described above for formula (A-1). In formula (B-2), each R³ is a group of formula OSi(R⁴)₃; each R⁴ is independently selected from the group consisting of R and DSi(R⁵)₃, where each R is an independently selected monovalent hydrocarbon group of 1 to 12 carbon atoms; each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the co-macromonomer of formula (B-2) has at least 6 silicon atoms per molecule. Alternatively, R⁴, R⁵, and R⁶ are selected such that the unit has at least 5 silicon atoms, alternatively at least 6 silicon atoms, alternatively 6 to 20 silicon atoms, alternatively 7 to 19 silicon atoms, alternatively 8 to 18 silicon atoms, alternatively 9 to 17 silicon atoms, and alternatively 10 to 16 silicon atoms, per molecule.

In formula (B-2), each R is a monovalent hydrocarbon group of 1 to 12 carbon atoms. The monovalent hydrocarbon group for R may be an alkyl group, such as an alkyl group of 1 to 6 carbon atoms. Alternatively, the alkyl groups may have 1 to 3 carbon atoms, alternatively 1 to 2 carbon atoms. Alternatively, each R group may be methyl.

In formula (B-2), each D is independently selected from the group consisting of an oxygen atom, a (poly)alkylene oxide group of 1 to 12 units, and a divalent hydrocarbon group of 2 to 4 carbon atoms.

The divalent hydrocarbon group for D may be exemplified by an alkylene group such as ethylene, propylene, or butylene; an arylene group such as phenylene, or an alkylarylene group such as:

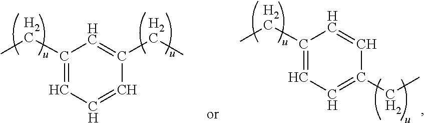

where each subscript u is independently 1 to 6, alternatively 1 to 2. Alternatively, the divalent hydrocarbon group for D may be alkylene, and alternatively the divalent hydrocarbon group for D may be ethylene.

The (poly)alkylene oxide group for D may have 2 to 4 carbon atoms per unit, e.g., have formula D⁵(OD⁶)_{v′}-OR, where D⁵ is an alkylene group of 2 to 4 carbon atoms, D⁶ is an alkylene group of 2 to 4 carbon atoms, R is as described above, and subscript v′ is 0 to 12. Alternatively subscript v′ may be 0 or 1. Alternatively, subscript v′ may be 0. Examples of (poly)alkylene oxide groups include ethyleneoxide-propyleneoxide.

Alternatively, each D may be selected from an oxygen atom and a divalent hydrocarbon group. Alternatively, each divalent hydrocarbon group for D may be an alkylene group such as ethylene. Alternatively, each D may be oxygen. Alternatively, some instances of D may be oxygen and other instances of D may be alkylene, e.g., ethylene, in the same unit.

Alternatively, formula (B-2) may comprise formula (B-2-1):

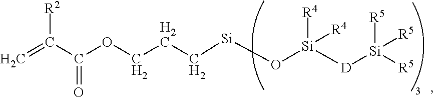

where R², R⁴, and R⁵ are as described above.

Alternatively, formula (B-2) may comprise formula (B-2-2):

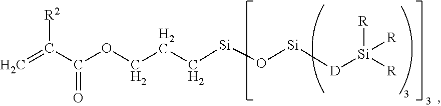

where R², D, and R are as described above.

Alternatively, formula (B-2) may comprise formula (B-2-3):

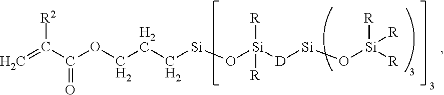

where R², D, and R are as described above.

Alternatively, formula (B-2) may comprise a co-macromonomer selected from the group consisting of:
3-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl) propyl methacrylate of formula

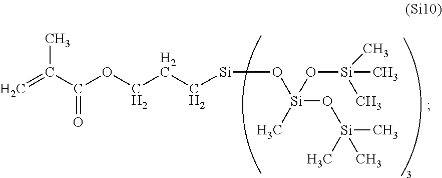

3-(1,5-bis(2-(1,1,1,5,5,5-hexamethyl-3-((trimethylsilyl)oxy)trisiloxan-3-yl)ethyl)-3-(((2-(1,1,1,5,5,5-hexamethyl-3-((trimethylsilyl)oxy)trisiloxan-3-yl)ethyl)dimethylsilyl)oxy)-1,1,5,5-tetramethyltrisiloxan-3-yl) propyl methacrylate, which has formula

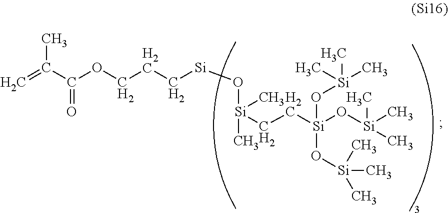

and a combination thereof. The co-macromonomer of formula (B-2) as described and exemplified above may be prepared by known methods, such as those disclosed in PCT Publication WO2020142388 and U.S. Pat. No. 6,420,504.

Starting material (A) the silicone-(meth)acrylate macromonomer, and starting material (B) the silicone-(meth)acrylate co-macromonomer are used in the following amounts when making the copolymer: starting material (A) is used in an amount of >25 weight % to 100 weight %, based on combined weights of starting materials (A) and (B); and starting material (B) is used in an amount of 0 to <75 weight %, based on combined weights of starting materials (A) and (B). Alternatively, starting material (A) may be used in an amount >25%, alternatively at least 40%, alternatively at least 50%, alternatively at least 63%, and alternatively at least 75%, based on combined weights of starting materials (A) and (B); while at the same time the amount of starting material (A) may be up to 100%, alternatively up to 99%. Alternatively up to 95%, alternatively up to 75%, alternatively up to 63%, alternatively up to 50%, and alternatively up to 40%, on the same basis. Alternatively, the amount of starting material (A) may be 100%, and the amount of starting material (B) may be 0. Alternatively, starting material (B) may be present, and the amount of starting material (B) may be >0%, alternatively at least 1%, alternatively up to 5%, alternatively up to 10%, alternatively up to 15%, alternatively up to 20%, and alternatively at least 25%; while at the same time the amount of starting material (B) may be up to 60%, alternatively up to 50%, alternatively up to 37%, and alternatively up to 25%, on the same basis. The starting materials used to make the copolymer may optionally be free of crosslinkable groups, for example, the starting materials that copolymerize in step 1) of the method described herein may be free of crosslinkable (meth)acrylate monomers such as organic (meth)acrylate monomers having crosslinkable groups. For example, the starting materials used in step 1) may be free of crosslinkable (meth)acrylate monomers such organic (meth)acrylate monomers having crosslinkable groups as (2-acetoacetoxy)ethyl methacrylate, hydroxybutyl (meth)acrylate, hydroxyethyl (meth)acrylate, hydroxyethylcaprolactone (meth)acrylate, hydroxypropyl (meth)acrylate, ureido (meth)acrylate, glycidyl (meth)acrylate (GMA), and poly(alkylene glycol) (meth)acrylate macromonomers such as poly(ethylene glycol) mono-(meth)acrylate (PEGMA) and poly(ethylene glycol) di(meth)acrylate. The starting materials used in step 1) may be free of organosilyl monomers having crosslinkable groups, such as alkenyltrialkoxysilanes (e.g., 3-(trimethoxysilyl) propyl (meth)acrylate, vinyltriethoxysilane and vinyltrimethoxysilane). Alternatively, the starting materials that copolymerize in step 1) may consist essentially of starting materials (A), (B), and (C), and when present (H).

Starting material (A), and when present starting material (B) are copolymerized in the presence of an additional starting material. The additional starting material comprises (C) an intiator. Alternatively, the starting materials that copolymerize in step 1) may consist of starting materials (A) the macromonomer, (B) the co-macromonomer, and (C) the initiator, and when present (H) the chain transfer agent. Alternatively, the starting materials used in step 1) may consist essentially of, or may consist of, (A) the macromonomer, (B) the co-macromonomer, (C) the initiator, (D) the surfactant, and (E) the water, and when present (H) the chain transfer agent, (I) the manganese ion source, and (J) the phenolic compound, and these starting materials are described further below.

Starting material (C), an initiator, is also added in step 1) described above. Suitable initiators include azo compounds and peroxide compounds. For example, the azo compound may be an aliphatic azo compound such as 1-t-amylazo-1-cyanocyclohexane, azo-bis-isobutyronitrile and 1-t-butylazo-cyanocyclohexane, 2,2′-azo-bis-(2-methyl) butyronitrile, 2,2′-azobis(2-methylpropionitrile), 2,2′-azobis(2-methylpropionamidine) dihydrochloride, 2,2′-azobis(cyanovaleric acid), or a combination of two or more thereof. Azo compounds are known in the art and are commercially available, e.g., under the tradename VAZO™ WSP from The Chemours Company of Wilmington, Delaware, USA. The peroxide compound may be a peroxide or a hydroperoxide, such as t-butylperoctoate, t-butyl perbenzoate, dicumyl peroxide, di-t-butyl peroxide, t-butyl hydroperoxide, cumene hydroperoxide, di-t-amyl peroxide and combinations of two or more thereof. Additionally, di-peroxide initiators may be used alone or in combination with other initiators. Such di-peroxide initiators include, but are not limited to, 1,4-bis-(t-butyl peroxycarbo)cyclohexane, 1,2-di(t-butyl peroxy)cyclohexane, and 2,5-di(t-butyl peroxy)-3-hexyne. Suitable peroxide compounds are known in the art and are commercially available from various sources, such as Sigma-Aldrich, Inc. Alternatively, the initiator may comprise isoascorbic acid.

An initiator may be used alone as starting material (C). Alternatively, starting material (C) may be a redox pair, which comprises an initiator as the oxidizing component and a reducing component. Alternatively, a redox pair including isoascorbic acid and an organic hydroperoxide such as t-amyl hydroperoxide or t-butyl hydroperoxide may be used as starting material (C). Examples of suitable initiators and/or redox pairs for starting material (C) are disclosed in U.S. Pat. No. 6,576,051 to Bardman et al., beginning at col. 11, line 16. How the initiator is added depends on various factors including whether the initiator is water soluble and the type of initiator (e.g., whether a thermal initiator or a redox pair is used). Typically, when a thermal initiator is used, all the initiator is added at once at the beginning of step 1). Alternatively, when a redox pair is used, it may be metered in over time.

Alternatively, the initiator may optionally further comprise Iron (II) sulfate heptahydrate, Potassium persulfate, or a combination thereof. The initiator (C) may be used in an amount sufficient to provide 0.01% to 3%, alternatively 0.1% to 1.5%, based on weight of the silicone-(meth)acrylate copolymer.

Starting material (D) is a surfactant. The surfactant may be selected from the group consisting of (D-1) a cationic surfactant, (D-2) a nonionic surfactant, and (D-3) a combination of both the cationic surfactant and the nonionic surfactant. Cationic surfactants useful herein include compounds containing quaternary ammonium hydrophilic moieties in the molecule which are positively charged, such as quaternary ammonium salts, which may be represented by formula (D-1-1): R¹²R¹³R¹⁴R¹⁵N⁺X′⁻ where R¹² to R¹⁵ are alkyl groups containing 1-30 carbon atoms, or alkyl groups derived from tallow, coconut oil, or soy; and X′ is a halogen, e.g., chlorine or bromine. Alternatively, the quaternary ammonium compounds may be alkyl trimethylammonium and dialkyldimethylammonium halides, or acetates, having at least 8 carbon atoms in each alkyl substituent. Dialkyl dimethyl ammonium salts can be used and are represented by formula (D-1-2): R¹⁶R¹⁷N⁺(CH₃)₂X′⁻ where R¹⁶ and R¹⁷ are alkyl groups containing 12-30 carbon atoms or alkyl groups derived from tallow, coconut oil, or soy; and X′ is halogen. Monoalkyl trimethyl ammonium salts can be used and are represented by formula (D-1-3): R¹⁸N⁺(CH₃)₃X″⁻ where R¹⁸ is an alkyl group containing 12-30 carbon atoms or an alkyl group derived from tallow, coconut oil, or soy; and X″ is halogen or acetate.

Representative quaternary ammonium halide salts are dodecyltrimethyl ammonium chloride/lauryltrimethyl ammonium chloride (LTAC), cetyltrimethyl ammonium chloride (CTAC), hexadecyltrimethyl ammonium chloride, didodecyldimethyl ammonium bromide, dihexadecyldimethyl ammonium chloride, dihexadecyldimethyl ammonium bromide, dioctadecyldimethyl ammonium chloride, dieicosyldimethyl ammonium chloride, and didocosyldimethyl ammonium chloride. These quaternary ammonium salts are commercially available under trademarks such as ADOGEN™, ARQUAD™, TOMAH™, and VARIQUAT™.

Other suitable cationic surfactants which can be used include fatty acid amines and amides and their salts and derivatives, such as aliphatic fatty amines and their derivatives. Such cationic surfactants that are commercially available include compositions sold under the names ARQUAD™ T27 W, ARQUAD™ 16-29, by Akzo Nobel Chemicals Inc., Chicago, Illinois; and Ammonyx Cetac-30 by the Stepan Company, Northfield, Illinois, USA.

The amount of (D-1) the cationic surfactant may be 0.1% to 5%, based on weight of starting material (F) the silicone-(meth)acrylate copolymer in the aqueous emulsion. Alternatively, the amount of cationic surfactant may be at least 0.1%, alternatively at least 0.2%, alternatively at least 0.3%, alternatively at least 0.4%, alternatively at least 0.5%; while at the same time the amount of cationic surfactant may be up to 5%, alternatively up to 4%, alternatively up to 3%, alternatively up to 2%, alternatively up to 1%, on the same basis. Alternatively, the amount of cationic surfactant may be 0.2% to 4%, alternatively 0.3% to 3%, alternatively 0.4% to 2.5%, and alternatively 0.5% to 2%; on the same basis.

Starting material (D-2) is a nonionic surfactant. Some suitable nonionic surfactants which can be used include polyoxyethylene alkyl ethers, polyoxyethylene alkyl phenyl ethers, alkylglucosides, polyoxyethylene fatty acid esters, sorbitan fatty acid esters, and polyoxyethylene sorbitan fatty acid esters. Nonionic surfactants which are commercially available include compositions such as (i) 2,6,8-trimethyl-4-nonyl polyoxyethylene ether sold under the names TERGITOL™ TMN-6 and TERGITOL™ TMN-10; (ii) the C11-15 secondary alkyl polyoxyethylene ethers sold under the names TERGITOL™ 15-S-7, TERGITOL™ 15-S-9, TERGITOL™ 15-S-15, TERGITOL™ 15-S-30, and TERGITOL™ 15-S-40, by the Dow Chemical Company, of Midland, Michigan, USA; octylphenyl polyoxyethylene (40) ether sold under the name TRITON™ X405 by the Dow Chemical Company; (iii) nonylphenyl polyoxyethylene (10) ether sold under the name MAKON™ 10 by the Stepan Company; (iv) ethoxylated alcohols sold under the name Trycol 5953 by Henkel Corp./Emery Group, of Cincinnati, Ohio, USA; (v) ethoxylated alcohols sold under the name BRIJ™ L23 and BRIJ™ L4 by Croda Inc. of Edison, New Jersey, USA, (vi) alkyl-oxo alcohol polyglycol ethers such as GENAPOL™ UD 050, and GENAPOL™ UD110, (vii) alkyl polyethylene glycol ether based on C10-Guerbet alcohol and ethylene oxide such as LUTENSOL™ XP 79.

Suitable nonionic surfactants also include poly(oxyethylene)-poly (oxypropylene)-poly(oxyethylene) tri-block copolymers. Poly(oxyethylene)-poly(oxypropylene)-poly (oxyethylene) tri-block copolymers are also commonly known as Poloxamers. They are nonionic triblock copolymers composed of a central hydrophobic chain of polyoxypropylene (poly(propylene oxide)) flanked by two hydrophilic chains of polyoxyethylene (poly(ethylene oxide)). Poly(oxyethylene)-poly(oxypropylene)-poly (oxyethylene) tri-block copolymers are commercially available from BASF of Florham Park, New Jersey, USA, and are sold under the tradename PLURONIC™, such as PLURONIC™ L61, L62, L64, L81, P84.

Other suitable nonionic surfactants include polyoxyethylene alkyl ethers, polyoxyethylene alkylphenol ethers, polyoxyethylene lauryl ethers, polyoxyethylene sorbitan monooleates, polyoxyethylene alkyl esters, polyoxyethylene sorbitan alkyl esters, polyethylene glycol (such as polyethylene glycol having 23 ethylene-oxide units), polypropylene glycol, diethylene glycol, ethoxylated trimethylnonanols, and polyoxyalkylene glycol modified polysiloxane surfactants. Commercially available nonionic surfactants which can be used include compositions such as 2,6,8-trimethyl-4-nonyloxy polyethylene oxyethanols (6EO) and (10EO) sold under the trademarks TERGITOL™ TMN-6 and TERGITOL™ TMN-10; alkyleneoxy polyethylene oxyethanol (C11-15 secondary alcohol ethoxylates 7EO, 9EO, and 15EO) sold under the trademarks TERGITOL™ 15-S-7, TERGITOL™ 15-S-9, TERGITOL™ 15-S-15; other C11-15 secondary alcohol ethoxylates sold under the trademarks TERGITOL™ 15-S-12, 15-S-20, 15-S-30, 15-S-40; octylphenoxy polyethoxy ethanol (40EO) sold under the trademark TRITON™ X-405; and alcohol ethoxylates with tradename ECOSURF™ EH, such as ECOSURF™ EH-40. All of these surfactants are sold by the Dow Chemical Company.

Other useful commercial nonionic surfactants are nonylphenoxy polyethoxy ethanol (10EO) sold under the trademark MAKON™ 10 by Stepan Company; polyoxyethylene 23 lauryl ether (Laureth-23) sold commercially by Sigma Aldrich, Inc. of St. Louis, Missouri, USA; and RENEX™ 30, a polyoxyethylene ether alcohol available from Fisher Scientific.

The nonionic surfactant may also be a silicone polyether (SPE). The silicone polyether as an emulsifier may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure. Suitable SPE's include DOWSIL™ OFX-5329 Fluid from Dow Silicones Corporation of Midland, Michigan, USA. Alternatively, the nonionic surfactant may be selected from polyoxyalkylene-substituted silicones, silicone alkanolamides, silicone esters and silicone glycosides. Such silicone-based surfactants may be used to form such aqueous emulsions and are known in the art, and have been described, for example, in U.S. Pat. No. 4,122,029 to Gee et al., U.S. Pat. No. 5,387,417 to Rentsch, and U.S. Pat. No. 5,811,487 to Schulz et al.

Starting material (D-2) the nonionic surfactant may be delivered in a dilution, and the amount used may be sufficient to provide 0.1% to 10% of the surfactant, based on weight of starting material (F) the silicone-(meth)acrylate copolymer in the aqueous emulsion. Alternatively, the amount of nonionic surfactant may be at least 0.1%, alternatively at least 0.2%, alternatively at least 0.3%, alternatively at least 0.4%, alternatively at least 0.5%, alternatively at least 1%, alternatively at least 2%, alternatively at least 3%, alternatively at least 4%; while at the same time the amount of nonionic surfactant may be up to 10%, alternatively up to 9%, alternatively up to 8%, alternatively up to 7%, alternatively up to 5%, alternatively up to 4%, alternatively up to 3%, alternatively up to 2%, alternatively up to 1%, on the same basis. Alternatively, the amount of nonionic surfactant may be 1% to 10%, alternatively 2% to 10%, alternatively 3 to 10%, alternatively 5% to 9%, alternatively 6% to 8%, and alternatively 7% %; on the same basis. Alternatively, starting materials (D-1) the cationic surfactant and (D-2) the nonionic surfactant may be present in combined amounts≤10%, based on weight of starting material (F) the silicone-(meth)acrylate copolymer in the aqueous emulsion.

Starting material (E) is water. The water is not generally limited, for example, the water may be processed or unprocessed. Examples of processes that may be used for purifying the water include distilling, filtering, deionizing, and combinations of two or more thereof, such that the water may be deionized, distilled, and/or filtered. Alternatively, the water may be unprocessed (e.g., may be tap water, i.e., provided by a municipal water system or well water, used without further purification). The amount of water is sufficient to form an aqueous emulsion for emulsion polymerization in step 1) of the process described above. Additional water may be added after step 1). For example, the aqueous emulsion prepared as described above may be diluted with additional water to achieve a desired amount of starting materials before treating a textile with the emulsion formulation. The water may be added in an amount of 20% to 97%, alternatively 30% to 90%, alternatively 40% to 80%, alternatively 50% to 97%, alternatively 50% to 90%, and alternatively 60% to 80%; based on combined weights of all starting materials in step 1). Alternatively, the water may be added in an amount of at least 20%, alternatively at least 30%, alternatively at least 40%, alternatively at least 50%, and alternatively at least 60%; while at the same time the amount of water may be up to 97%, alternatively up to 96%, alternatively up to 95%, and alternatively up to 80%, on the same basis.

The silicone-(meth)acrylate copolymer, (F), may be prepared by emulsion polymerization of starting materials comprising (A) the macromonomer and (C) the initiator (and optionally (B) the co-macromonomer) described above. Alternatively, the silicone-(meth)acrylate copolymer is a reaction product of starting materials consisting essentially of starting materials (A) the macromonomer and (C) the initiator (and when present, (B) the co-macromonomer and/or (H) the chain transfer agent). Alternatively, the silicone-(meth)acrylate copolymer is a reaction product of starting materials consisting of starting materials (A) and (C), (and, when present, (B) and/or (H)). Without wishing to be bound by theory, it is thought that none of starting materials (D) the surfactant and (E) the water copolymerize with starting materials (A) and (C), (and when present (B) and/or (H)), but that starting materials (D) and (E) merely serve as a vehicle for copolymerization. However, nothing herein shall exclude the possibility that a portion of one or more of starting materials (D) and/or (E), or any other starting material added during the method, may participate in the copolymerization reaction of starting materials comprising (A) and (C), and any optional starting materials (i.e., (B) and/or (H)), when present.

The silicone-(meth)acrylate copolymer comprises unit formula (F-1):

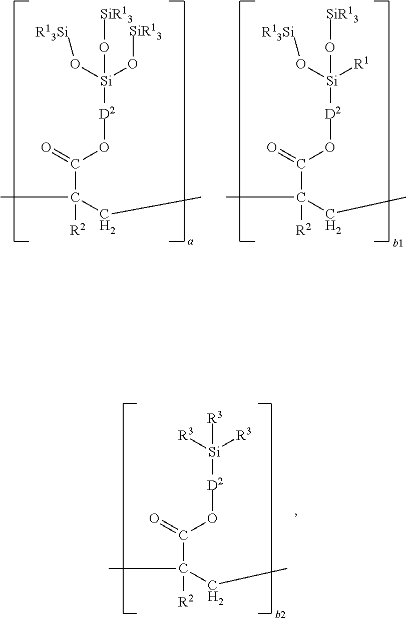

where each R¹ is an independently selected monovalent hydrocarbon group of 1 to 12 carbon atoms; each D² is independently a divalent hydrocarbon group of 2 to 12 carbon atoms; and each R² is independently selected from the group consisting of H and methyl; each R³ is a group of formula OSi(R⁴)₃; where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the silicone-(meth)acrylate co-macromonomer unit with subscript b2 has at least 5 silicon atoms; subscripts a, b1, and b2 represent weight fractions of units in the copolymer, and subscripts a, b1, and b2 have values such that 0.25<a≤1; and 0≤(b1+b2)<0.75; and the silicone-(meth)acrylate copolymer further comprises a terminal moiety. In the unit formula (F-1), R¹, R², R³, R⁴, R⁵, R⁶, R, D, and D² are as described and exemplified above for formulas (A-1), (B-1) and (B-2). Alternatively, in the unit formula (F-1) for the silicone-(meth)acrylate copolymer, each R¹ may be methyl, each R² may be methyl, each D² may be propylene, each R³ may be the group of formula OSi(R⁴)₃; where each R⁴ is independently selected from the group consisting of R and OSi(R⁵)₃, where each R is methyl; each R⁵ is independently selected from the group consisting of R and OSi(R⁶)₃; where each R⁶ is independently selected from the group consisting of R and OSiR₃; with the proviso that R⁴, R⁵, and R⁶ are selected such that the silicone-(meth)acrylate co-macromonomer 10 to 16 silicon atoms per molecule. Alternatively, subscript a may have a value such that 0.50≤a≤1, alternatively 0.63≤a≤1, alternatively 0.75≤a≤1, and alternatively a=1. Alternatively, subscript b1 may have a value such that 0≤b1<0.75, alternatively 0≤b1≤0.5, alternatively 0≤b1<0.25, and alternatively b1=0. Alternatively, subscript b2 may have a value such that 0≤b2<0.75, alternatively 0.01≤b2≤0.5, alternatively 0.05≤b1<0.25, and alternatively b1=0.25.

The silicone-(meth)acrylate copolymer prepared as described above may have a weight average molecular weight measured by GPC of >181,000 g/mol. Alternatively, silicone-(meth)acrylate copolymer may have a weight average molecular weight measured by GPC of at least 200,000 g/mol; alternatively at least 210,000 g/mol; alternatively at least 212,000 g/mol; alternatively at least 225,000 g/mol; alternatively at least 230,000 g/mol; and alternatively at least 234,000 g/mol; while at the same time, weight average molecular weight may be up to 2,000,000 g/mol; alternatively up to 1,000,000 g/mol; alternatively up to 950,000 g/mol; alternatively up to 925,000 g/mol; alternatively up to 912.000 g/mol, alternatively up to 900,000 g/mol, alternatively up to 850,000 g/mol; alternatively up to 800,000 g/mol; and alternatively up to 750,000 g/mol; and alternatively up to 721,000 g/mol. Alternatively, the silicone-(meth)acrylate copolymer may have a weight average molecular weight of 212,000 g/mol to 912,000 g/mol, measured by GPC. The samples for GPC analysis may be prepared in THF eluent at concentration 10 mg/mL copolymer. The solution may be shaken on a flat-bed shaker at ambient temperature for 2 hours. The solution may then be filtered through a 0.45 m PTFE syringe filter prior to injection. A Waters e2695 LC pump and autosampler, equipped with two 5 uM Agilent PLG gel Mixed C columns in series and Shodex RI501 differential refractive index detector was used to analyze the samples. The instrument was equilibrated for 30 min at 1 mL/min and samples were run at 1 mL/min. Agilent GPC software Cirrus version 3.3 may be used for data collection and for data reduction. A total of 16 polystyrene linear narrow molecular weight standards from Agilent having Mp values from 3750 to 0.58 kg/mol may be used for molecular weight calibration. A 3^{rd} order polynomial was used for calibration curve fitting. Thus, all molecular weight averages, distributions and references to molecular weight provided in this report are polystyrene equivalent values.

Starting material (G) is a blocked isocyanate that is added to the emulsion formulation suitable for treating textiles. The term “blocked isocyanate” encompasses mono-, di- and polyisocyanates in which an isocyanate group has been reacted with a blocking agent, which upon heating, release the isocyanate and the blocking agent. Suitable blocking agents are known in the art such as amines, amides, compounds having an active hydrogen atom, alcohols, or oximes. Blocked isocyanates are commercially available, such as ARKOPHOB™ DAN and ARKOPHOB™ SR from Archroma of Pratteln, Switzerland; RUCO™-GUARD WEB and RUCO™-LINK XCR from Rudolf GmbH of Geretsreid, Bayern, Germany, and PHOBOL™ EXTENDER UXN and PHOBOL™ EXTENDER XAN from Archroma. Alternatively, the blocked isocyanate may be an oxime blocked isocyanate, such as PHOBOL™ EXTENDER XAN. Alternatively, the blocked isocyanate may comprise a nitrogen containing heterocycle (N-heterocycle)-blocked isocyanate. The N-heterocycle-blocked isocyanate comprises an isocyanate compound and an N-heterocycle-blocking agent. The isocyanate compound may be monomeric or polymeric. The isocyanate compound may comprise, or maybe, a unit selected from the group consisting of IPDI, H₁₂MDI, TMXDI, TMI, XDI, H₆XDI, MDI, and HDI. Alternatively, the polyisocyanate may be an aliphatic isocyanate where the NCO group is not directly attached to an aromatic ring. Alternatively, the polyisocyanate may be HDI or MDI. The N-heterocycle blocking agent may be 2,6-dimethylpyrazine or a dimethylpyrazole, e.g., 3,5-dimethylpyrazole. Without wishing to be bound by theory, it is thought that the blocked isocyanate may be free of species that may interfere with the performance of the isocyanate in the emulsion formulation, such as silicones and amines (that are not within the blocking group). And, without wishing to be bound by theory, it is thought that the blocked isocyanate may be delivered in an emulsion or dispersion that is free of anionic surfactant. Suitable aqueous additives are commercially available and may be delivered in aqueous dispersions, and examples thereof are shown below in Table 0.

TABLE 0
Commercially Available Aqueous Additives

| Name | Description | Source |
|---|---|---|
| PHOBOL ™ | aqueous dispersion comprising 5 - 30% aliphatic blocked | Archroma |
| EXTENDER | with 3,5-dimethylpyrazole. PHOBOL ™ EXTENDER | |
| UXN | UXN may be free of butanone oxime | |
| PHOBOL ™ | aqueous dispersion comprising 5 - 30% phenyl blocked | Archroma |
| EXTENDER | with butanone oxime. PHOBOL ™ EXTENDER UAN | |
| XAN | may be free of butanone oxime | |
| RUCO ™-LINK | Blocked aliphatic isocyanate | Rudolf |
| XCR | | Group |

The exact amount of (G) the blocked isocyanate compound depends on various factors including the type and amount of (F) silicone-(meth)acrylate copolymer formed in step 1) and the textile to be treated, however, the weight of (G) the blocked isocyanate may be sufficient to provide 0.25% to 3.75% on fabric weight, alternatively 0.25% to 1%, and alternatively 0.25% to 0.5%, on the same basis.

An additional starting material that may be added in step 1) of the method described above comprises (H) a chain transfer agent. Suitable chain transfer agents include mercaptans such as alkyl mercaptans, e.g., n-octyl mercaptan, n-dodecyl mercaptan, dodecyl mercaptan (dodecane thiol), and/or 2,2-dimethyldecyl mercaptan. Alternatively, the chain transfer agent may be water soluble, such as mercaptoacetic acid and/or 2-mercaptoethanol. Suitable chain transfer agents are known in the art and have been disclosed, for example, in “Radical Polymerization in Industry” by Peter Nesvadba, Performance Chemical Research, GASF Schweiz AG, Basel, Switzerland, Encyclopedia of Radicals in Chemistry, Biology and Materials, Online @ 2012 John Wiley & Sons, Ltd.

Starting material (H) is optional and may be added in an amount of 0 to 1%, based on combined weights of starting material (A), and when present starting material (B). Alternatively, (H) the chain transfer agent may be used in an amount of 0.5% to 0.6% on the same basis.

Starting material (I) is an optional manganese ion source, which may be a manganese (II) compound. Suitable manganese compounds include manganese (II) acetate, manganese (II) nitrite, manganese (II) propionate, manganese (II) oxide, manganese (II) hydroxide, manganese (II) chloride, manganese (II) phosphate, manganese (II) perchlorate, hydrates thereof (e.g., manganese (II) acetate tetrahydrate) and combinations thereof. Alternatively, the manganese ion source may comprise manganese (II) acetate or manganese (II) acetate tetrahydrate, or a combination thereof. Suitable manganese ion sources are commercially available from Millipore Sigma of St. Louis, Missouri, USA, Fisher Scientific of Waltham, Massachusetts, USA, and City Chemical LLC of Connecticut, USA. The amount of manganese ion source depends on various factors including the selections and amounts of other starting materials used, however the amount may be 0.1 ppm to 5,000 ppm based on combined weights of starting material (A), and when present starting material (B). Alternatively, the amount of the manganese ion source may be >0 ppm, alternatively at least 0.5 ppm, alternatively at least 1 ppm, alternatively at least 1.5; while at the same time, the amount of manganese ion source may be up to 10 ppm, alternatively up to 5 ppm, alternatively up to 4 ppm, and alternatively up to 3 ppm, and alternatively up to 2 ppm, based on combined weights of all starting materials in the emulsion formulation for treating the textile.

Starting material (J) is an optional phenolic compound. Suitable phenolic compounds include hydroquinone (HQ), 2-methylhydroquinone, 2-t-butylhydroquinone, dihydroxybenzene (catechol), 4-di-t-butyl dihydroxybenzene (4-di-t-butyl catechol), resorcinol, dihydroxyxylene, methoxyphenols such as guaiacol, p-methoxyphenol (also called methyl ether of hydroquinone or MeHQ), tert-butyl hydroquinone (tBuHQ), pyrogallol, methylpyrogallol, cresol, phenol, xylenols, butylated hydroxyl toluene, N-nitroso phenylhydroxylamine, butylated hydroxy anisole, and combinations thereof. Alternatively, the phenolic compound may be selected from the group consisting of HQ, MeHQ, tBuHQ, and a combination of two or more thereof. Suitable phenolic compounds are commercially available, e.g., from Millipore Sigma of St. Louis, Missouri, USA. The amount of phenolic compound source depends on various factors including the selections and amounts of other starting materials used, however the amount may be 5 ppm to 5,000 ppm based on combined weights of starting material (A) and when present starting material (B). Alternatively, the amount of the phenolic compound may be at least 5 ppm, alternatively at least 50 ppm, alternatively at least 100 ppm, alternatively at least 150 ppm; while at the same time, the amount of phenolic compound may be up to 500 ppm, alternatively up to 400 ppm, alternatively up to 350 ppm, and alternatively up to 320 ppm, based on combined weights of all starting materials in the emulsion formulation for treating the textile.

Alternatively, another inhibitor may be used in addition to, or instead of, (I) the manganese ion source and (J) the phenolic compound described above. For example, the inhibitor may comprise, or may be, nitrobenzene; 2,2-diphenyl-1-picrylhydrazyl (DPPH); phenothiazine; N,N-diethylhydroxylamine; (2,2,6,6-tetramethylpiperidin-1-yl) oxidanyl (TEMPO); 4-hydroxy-(2,2,6,6-tetramethylpiperidin-1-yl) oxidanyl (4-hydroxy TEMPO); or a combination of two or more thereof.

Starting material (K) is an optional biocide. The amount of biocide will vary depending on factors including the type of biocide selected and the benefit desired. However, when used, the amount of biocide may be >0% to 5% based on the combined weights of all starting materials in the emulsion formulation. Starting material (K) is exemplified by (K-1) a fungicide, (K-2) an herbicide, (K-3) a pesticide, (K-4) an antimicrobial agent, or a combination thereof. Suitable biocides are disclosed, for example, in U.S. Pat. No. 9,480,977.

The emulsion formulation suitable for treating the textile may optionally further comprise starting material (P), a penetrating agent. Suitable penetrating agents are exemplified by glycol ethers, which are commercially available from The Dow Chemical Company and include DOWANOL™ DPM, TPM, PPh, EPh, Methyl CARBITOL™, and Butyl CARBITOL™.

The emulsion formulation suitable for treating the textile may optionally further comprise an amount sufficient to impart softness to a textile without significantly decreasing water and/or oil repellency of (Q) a softening additive selected from (Q-1) an alkylpolysiloxane of formula

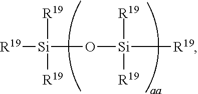

where each R¹⁹ is an independently selected monovalent saturated hydrocarbon group having 1 to 18 carbon atoms, and subscript aa has an average value of 20 to 300, or (Q-2) a combination comprising 60 to 70 weight %, based on combined weights of all starting materials in (Q-2), the combination, of (Q-1) the alkylpolysiloxane, 29 to 39 weight %, based on combined weights of all starting materials in (Q-2), the combination, of (Q-2-1) a silicone resin having a hardness≥20 measured by Type A durometer according to JIS K 6249:2003, and 0 to 2 weight %, based on combined weights of all starting materials in (Q-2), the combination, of (Q-2-2) an amino-functional polyorganosiloxane having a functional group equivalent of 100 g/mol to 20,000 g/mol, wherein the equivalent means molecular weight of the amino-functional polyorganosiloxane per 1 mole of nitrogen atoms, and having a kinematic viscosity at 25° C. of 10 to 100,000 mm²/s measured by the method of JIS K 2283:2000. Alternatively, (Q-2-2) the amino-functional polyorganosiloxane may be present in an amount of 1% to 2%, on the same basis.

The (Q-1) alkylpolysiloxane has formula

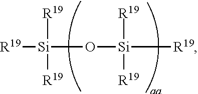

where each R¹⁹ is an independently selected monovalent saturated hydrocarbon group having 1 to 18 carbon atoms, and subscript aa has an average value of 20 to 300. The monovalent saturated hydrocarbon group for R¹⁹ may be an alkyl group, alternatively an alkyl group of 1 to 6 carbon atoms. Alternatively, the alkyl groups may have 1 to 3 carbon atoms, alternatively 1 to 2 carbon atoms. Alternatively, each R¹⁹ may be methyl. Suitable alkylpolysiloxanes, e.g., bis-trimethylsiloxy-terminated polydimethylsiloxanes, are known in the art and are commercially available, e.g., as XIAMETER™ 200 Fluids from The Dow Chemical Company of Midland, Michigan, USA.

Alternatively, (Q) the softening additive may comprise a (Q-2) combination comprising: 60 to 70 weight %, based on combined weights of all starting materials in (Q-2), the combination, of (Q-1) the alkylpolysiloxane described above, 29 to 39 weight %, based on combined weights of all starting materials in (Q-2), the combination, of (Q-2-1) a silicone resin having a hardness≥20 measured by Type A durometer according to JIS K 6249:2003, and 1 to 2 weight %, based on combined weights of all starting materials in (Q-2), the combination, of (Q-2-2) an amino-functional polyorganosiloxane having a functional group equivalent of 100 to 20,000 g/mol, wherein the equivalent means molecular weight of the amino-functional polyorganosiloxane per 1 mole of nitrogen atoms, and having a kinematic viscosity at 25° C. of 10 to 100,000 mm²/s measured by the method of JIS K 2283:2000.

Starting material (Q) the softening additive may be delivered in a second aqueous emulsion, which comprises (Q) the softening additive, (D′) a surfactant (which may be as described above for starting material (D) the surfactant) and (E′) water (which may be as described above for starting material (E)). The second aqueous emulsion may be prepared by known methods, such as those described in U.S. Patent Application Publication 2020/0332148, by varying the types and amounts of starting materials as described herein.

When selecting starting materials to add to the aqueous emulsion prepared as described above in step 1) and the emulsion formulation formed in step 2) described above, there may be overlap between types of starting materials because certain starting materials described herein may have more than one function. The starting materials used in aqueous emulsion and/or the emulsion formulation, may be distinct from one another.

The emulsion formulation suitable for treating the textile comprises: (F) the silicone-(meth)acrylate copolymer, (D) the surfactant, (E) the water, and (G) the blocked isocyanate, as described above. The emulsion formulation may optionally further comprise an additional starting material selected from the group consisting of (I) the manganese ion source, (J) the phenolic compound, (K) the biocide, (L) additional water (as described above for starting material (E)), (M) the flame retardant, (N) the wrinkle reducing agent, (O) the antistatic agent, (P) the penetrating agent, (Q) the softening additive, and a combination of two or more of starting materials (K), (L), (M), (N), (O), (P), and (Q). These additional starting materials and their amounts are as described above. Furthermore, the emulsion formulation described herein may be formulated with starting materials that are fluorocarbon-free. For example, the emulsion formulation may be free of any starting material that contains a fluorine atom covalently bonded to a carbon atom.

The emulsion formulation prepared as described above may be used for treating a textile. For example, a method for treating a textile comprises: I) coating the textile with the emulsion formulation described above, and II) heating the textile. Step I) may be performed by any convenient method, such as padding, dipping, or spraying the textile with the emulsion formulation. However, the method should be sufficient to deliver a sufficient amount of (F) the silicone-(meth)acrylate copolymer and (G) the blocked isocyanate sufficient to impart durable oil resistance properties to the textile, according to the methods described below. The method may be sufficient to deliver on fabric weight of 0.25 weight % to 10 weight % of (F), the silicone-(meth)acrylate copolymer, and on fabric weight of 0.1 weight % to 3.75 weight %, alternatively 0.25% to 1%, of (G), the blocked isocyanate, both based on weight of the textile.

Step II) may be performed by any convenient method, such as placing the textile in an oven. Heating the textile may be performed to remove all or a portion of the water and/or cure the emulsion formulation. The exact temperature depends on various factors including the temperature sensitivity of the type of textile selected and the desired drying time. However, heating may be performed at a temperature>100° C. to remove water. Alternatively, the temperature may be >100° C. to 200° C. for a time sufficient to remove all or a portion of the water, de-block the blocked isocyanate, and/or cure (F) the silicone-(meth)acrylate copolymer.

The textile to be treated is not specifically restricted. Suitable textiles include naturally derived textiles such as fabrics of cotton, silk, linen, and/or wool; textiles derived from synthetic sources such as rayon, acetate, polyesters, polyamides (such as Nylons), polyacrylonitriles, and polyolefins such as polyethylenes and/or polypropylenes, and combinations of two or more thereof (e.g., blends such as polyester/cotton blend). The form of the textile is also not specifically restricted. The emulsion formulation described herein is suitable for use on textiles in any form, e.g., woven fabrics, knitted fabrics, or nonwoven textiles.

### EXAMPLES

The following examples are provided to illustrate the invention to one skilled in the art and are not to be construed as limiting the scope of the invention set forth in the claims.

TABLE 1
Starting Materials

| Starting Material | | | |
|---|---|---|---|
| Type | Abbreviation | Chemical description | Source |
| (B-2) Co- | Si16 | (Si16) shown above | prepared as |
| Macromonomer 1 | | | described |
| | | | above |
| (A) | (3MT-ALMA) | (3MT-ALMA) shown above | Gelest |
| Macromonomer 2 | | | |
| (B-2) Co- | Si10 | (Si10) shown above | Prepared as |
| Macromonomer 3 | | | described |
| | | | above |
| (B-1) | MDM-ALMA | (MDM-ALMA) shown | prepared as |
| Macromonomer 4 | | above | described |
| | | | above |
| Solvent | Water | | Local water |
| | | | source |
| Initiator 1 | AIBN | 2,2′-Azobis(2- | Sigma |
| | | methylpropionamidine) | |
| | | dihydrochloride | |
| Inhibitor 1 | Inhibitors | Manganese (II) acetate | |
| | Mn/HQQ/MeHQ | tetrahydrate; hydroquinone; | |
| | | and 4-methoxyphenol | |
| Additive (blocked | Phobol ™ Extender XAN | Oxime blocked isocyanate | Archroma |
| isocyanate) | | | |
| Surfactant | Ecosurf ™ EH40 | 75% solids, 25% water | Dow |
| (nonionic) | | | |
| SA | stearyl acrylate | | BASF |
| Comparative Co- | 3MT-1C | (1,1,1,5,5,5-hexamethyl-3- | Sigma |
| macromonomer | | ((trimethylsilyl)oxy)trisiloxan- | |
| | | 3-yl)methyl methacrylate, | |
| | | shown below | |
| Fabric 1 | Nylon | Nylon fabric (style #01194) | Burlington |
| | | was 127 g/m², 99% | |
| | | polyamide/1% spandex | |
| Fabric 2 | PES | polyester fabric (style | Burlington |
| | | #4774075) is 220 g/m², | |
| | | Woven (crepe) | |

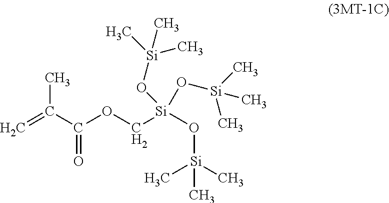 [SMILES: C=C(C)C(=O)OC[Si](O[Si](C)(C)C)(O[Si](C)(C)C)O[Si](C)(C)C]

In this Reference Example 1, silicone-(meth)acrylate copolymer emulsions were prepared as follows. All macromonomers, water and surfactant were added to a widemouth jar (˜400 mL) in selections and amounts shown below in Table 2. A sonicator was used to make an emulsion (Fisherbrand Model 705 sonic dismembrator, amplitude 50, Power ˜62 W, for 2 min). The aqueous emulsion was then transferred to a reactor and heated to 65° C. After the aqueous emulsion came to temperature, Initiator 1 was added (0.26 g), and the reactor contents were stirred for 6 h. The reactor contents were then cooled down to room temperature and the resulting copolymer emulsions were each poured into a bottle.

TABLE 2
Copolymer Preparation Via Emulsion Polymerization

| Copolymer | EH40 | Si16 | 3MT- | MDM- | 3MT- | Si10 | SA | Water |
|---|---|---|---|---|---|---|---|---|
| Emulsion | (g) | (g) | ALMA (g) | ALMA (g) | 1C | (g) | (g) | (g) |
| 1 | 3.75 | 0 | 39.97 | 0 | 0 | 0 | 0 | 93.83 |
| 2 | 3.75 | 14.97 | 24.97 | 0 | 0 | 0 | 0 | 93.86 |
| 3 | 3.75 | 0 | 19.98 | 0 | 0 | 20 | 0 | 93.83 |
| 4 | 3.75 | 0 | 29.97 | 0 | 0 | 9.98 | 0 | 93.86 |
| 5* | 3.76 | 0 | 30.00 | 9.99 | 0 | 0 | 0 | 93.89 |
| 6 (Comp) | 3.75 | 0 | 10.04 | 0 | 0 | 30 | 0 | 93.83 |
| 7 (Comp) | 4.68 | 0 | 0 | 0 | 49.91 | 0 | 0 | 117.52 |
| 8 (Comp) | 3.73 | 0 | 27.96 | 0 | 0 | 0 | 11.99 | 93.85 |

*0.4 g of a 2.5 wt % water solution of 4-methoxyphenol, 0.006 g of hydroquinone and 0.12 g of 0.7 wt % water solution of Mn(II)acetate tetrahydrate.

In this Reference Example 2, emulsion formulations were prepared, fabrics were treated, and oil repellency was evaluated as follows: All the fabrics were washed/dried before coating. The amount of water pickup for each fabric was measured and then emulsion formulations were made based on that pick up weight by adding a blocked isocyanate Additive. Table 3 provides the exact emulsion formulations recipes. Each emulsion formulation was then poured into Mathis HVF padder (roll speed of 2 m/min at 60 psi) for coating. The fabric was passed through the coater until not more dry spots were observed (generally twice) then placed through a forced air Mathis LTF oven at 160° C. for 3 min. The fabric was weighed both before coating and after coating to get the actual weight coated. Each sample was ˜2 wt % on fabric.

In Example 7, the sheets were laundered using a 90° F. wash followed by a cold rinse cycle (˜70° F.) in a Whirlpool model WTW4855HW1 washing machine (settings: normal cycle, hot wash temperature, deep water wash, auto sensing rinse). Tide Free and Gentle Liquid Laundry Detergent was used as the detergent using 39 g for 6 pound loads of fabric. For smaller loads, the detergent amount was modified proportionally. The hot water for washing the samples went through a building wide water softening system. The cold water was also softened and went through a PDIMX-60 water softener system from Franklin Electric using the standard settings (default 20 setting for hardness). A Whirlpool model WED4850HW0 dryer was used to dry the samples (auto dry cycle on high ˜140° F.).

TABLE 3
Emulsion Formulations and Oil Repellency Results

| | Emulsion Formulation | | | | | | | | |
|---|---|---|---|---|---|---|---|---|---|
| | | Copolymer | Additive | Water | Fabric | | AATCC 118 | | |
| | Co- | mass | (XAN) | mass | | # of | 0 | 1 | 5 |
| Example | polymer | (g) | mass (g) | (g) | type | Washes | s | min | min |
| 1 | 1 | 7.66 | 0.93 | 91.41 | PES | 0 | A | A | A |
| 2 | 2 | 7.66 | 0.93 | 91.41 | PES | 0 | A | A | A |
| 3 | 3 | 5.75 | 0.69 | 68.56 | PES | 0 | A | A | A |
| 4 | 4 | 5.75 | 0.69 | 68.56 | PES | 0 | A | A | A |
| 5 | 1 | 12.77 | 1.54 | 85.69 | Nylon | 0 | A | A | B |
| 6 | 2 | 12.77 | 1.54 | 85.69 | Nylon | 0 | A | A | B |
| 7* | 1 | 7.66 | 0.93 | 91.41 | PES | 5 | A | A | A |
| 8*** | 5 | 5.36 | 0.65 | 63.99 | PES | 0 | A | A | A |
| Comp 1 | 6 | 5.75 | 0 | 69.25 | PES | 0 | A | C | D |
| Comp 2 | 1 | 7.66 | 0 | 92.34 | PES | 0 | B | D** | — |
| Comp 3 | 2 | 7.66 | 0 | 92.34 | PES | 0 | B | D** | — |
| Comp 4 | 7 | 5.75 | 0 | 69.25 | PES | 0 | B | D | D |
| Comp 5 | 4 | 5.75 | 0 | 69.25 | PES | 0 | A | D | D |
| Comp 6 | 8 | 7.66 | 0.93 | 91.41 | PES | 0 | A | B | D |
| Comp 7 | 5 | 5.36 | 0 | 64.64 | PES | 0 | A | C | C |

A modified version of American Association of Textile Chemists and Colorists (AATCC) standard test method 118 was used to determine oil repellency (face ranking). The face rankings of A, B, C, and D were used as described in AATCC 118 (and as shown in FIG. 3 of “Fluorine-free low surface energy organic coating for anti-stain applications” by Lei, et al, Progress in Organic Coatings 103 (2017) 182-192, 184. Face ranking of A denoted a clear, well-rounded bead of oil; B denoted a rounding drop with partial darkening; C denoted wick was apparant and/or complete wetting; and D denoted complete wetting.) The modifications to this test method were that the oil used was olive oil, and the time was extended from 10 sec to 5 min. Passing required a rating of A or B after 5 min. Face rating of C or D represented unacceptably high oil absorbance by the fabric. A relatively large olive oil drop was used for this test, i.e., at least 500 μL per drop.

In Table 3, * denotes that the sample was washed 5 times before testing oil repellency, ** denotes a value taken after 10 seconds instead of 1 minute, and *** denotes that this sample also had a face ranking of A when the value was taken again after 15 minutes. The data in Table 3 show that presence of the blocked isocyanate Additive dramatically increased oil repellency. For example, Example 1 and Comparative Example 2 (Comp 2) contained the same starting materials (i.e., emulsion of copolymer of 3MT-ALMA), except the blocked isocyanate was present in Example 1 and absent from Comp 2. Example 1 had dramatically improved oil repellency under all conditions tested. Similarly, Example 4 showed dramatically improved oil repellency over Comparative Example 5 after 1 minute and 5 minutes. Comparative Example 6 demonstrates that using stearyl acrylate in the copolymer unexpectedly does not provide pass performance. Example 7 demonstrated unexpected wash durability without the any added cross-link points in the copolymer backbone. Examples 1, 2, 5 and 6 demonstrated that multiple fabric types can be rendered oil repellent using the emulsion formulation described herein. Furthermore, Example 1 and Comparative Example 2 demonstrated that oil repellency improved when the isocyanate additive was used.

Additional samples were prepared and evaluated as follows:

### Method A

In this Synthesis Example 1, silicone-(meth)acrylate copolymer emulsions were prepared as follows. All all starting materials (except initiator) were added to a widemouth jar (˜400 mL) in selections and amounts shown below in Table 4. A sonicator was used to make an emulsion (Fisherbrand Model 705 sonic dismembrator, amplitude 50, Power ˜62 W, for 2 min). The aqueous emulsion was then transferred to a reactor and heated to 65° C. After the aqueous emulsion came to temperature, 2,2′-Azobis(2-methylpropionamidine) dihydrochloride (AIBN) was added (0.26 g), and the reactor contents were stirred for 6 h. The reactor contents were then cooled down to room temperature and the resulting aqueous copolymer emulsions were each poured into a bottle. The aqueous copolymer emulsions prepared as described above are summarized below in Table 4. Amounts of each starting material in Table 4 are in grams.

### Method B

In this Synthesis Example 2, a silicone-(meth)acrylate copolymer emulsion was prepared as follows. All all starting materials (except initiator) were added to a widemouth jar (˜400 mL) in selections and amounts shown below in Table 4. The stearyl acrylate monomer was melted first and added as a liquid. In addition, the emulsions were inhibited with Hydroquinone (50 ppm based on monomer), Mn(II) acetate*4H₂O (1.5 ppm based on monomer) and methyletherhydroquinone (150 ppm based on monomer). The resulting material was sonicated at an amplitude of 50 for two minutes using a sonicator (Fisher Brand Sonic Dismembrator) to create an emulsion. The resulting emulsion was then transferred to a 500 mL 4 neck flask equipped with a reflux condenser, nitrogen inlet, overhead stirrer (IKA RW20) and thermocouple probe. This emulsion was stirred at 250 RPM using a Teflon blade and heated to 65° C. After reaching temperature 0.25 g of 2,2′ Azobis(2-methylpropionamidine dichloride was added and the reaction was run for 6 hours. The resulting material was then allowed to cool to 30 to 40° C. with slow stirring before pouring off. The aqueous copolymer emulsions prepared as described above are summarized below in Table 4. Amounts of each starting material in Table 4 are in grams.

In preparation for Method C, several solutions were prepared as follows:
Solution A preparation: Added 0.0566 g of t-butylhydroperoxide (70% in water) and then enough water to make a 10 g solution. Solution B preparation: Added 0.0773 g of isoascorbic acid and then enough water to make a 10 g solution. Solution C preparation: Added 6 mg iron (II) sulfate heptahydrate and then enough water to make a 10 g solution.

### Method C

In this Synthesis Example 3, emulsions were prepared as follows. Starting materials were weighed into a 400 mL wide mouth jar selections and amounts shown below in Table 4. The stearyl and behenyl acrylate monomers were melted first and added as a liquid. In addition, the emulsions were inhibited with Hydroquinone (50 ppm based on monomer), Mn(II) acetate*4H₂O (1.5 ppm based on monomer) and methyletherhydroquinone (150 ppm based on monomer). The resulting material was sonicated at an amplitude of 50 for two minutes using a sonicator (Fisher Brand Sonic Dismembrator) to create an emulsion. The coarse emulsion is then, passed through a microfluidizer (Microfluidics Microfluidizer 110Y) and set to 1,000 psi, twice. The aqueous emulsion was then transferred to a reactor and heated to 65° C. After the aqueous emulsion came to temperature, 2,2′-Azobis(2-methylpropionamidine) dihydrochloride (AIBN) was added (0.26 g), and the reactor contents were stirred for 6 h. The reactor contents were then cooled down to room temperature and the resulting aqueous copolymer emulsions were each poured into a bottle. The aqueous copolymer emulsions prepared as described above are summarized below in Table 4. Amounts of each starting material in Table 4 are in grams.

TABLE 4
Starting Materials used for Syntheses according to Methods A-C- in Synthesis Examples 1 to 3

| Copolymer | 1 | 1 | 2 | 3 | 4 | 5 | 6 | 7 | 8 |
|---|---|---|---|---|---|---|---|---|---|
| (Method) | (A) | (C) | (C) | (A) | (A) | (C) | (C) | (C) | (B) |
| Deionized water | 85.17 | 85.17 | 85.14 | 85.18 | 85.16 | 85.2 | 85.11 | 85.18 | 67.72 |
| Ecosurf EH-40 | 3.42 | 3.42 | 3.35 | 3.4 | 3.39 | 3.4 | 3.37 | 3.37 | 4.82 |
| 3MT-ALMA | 36.25 | 36.25 | 36.29 | 36.28 | 36.27 | 36.24 | 36.25 | 36.26 | 36.26 |
| 4-methoxyphenol | 0.36 | 0.36 | 0.37 | 0.37 | 0.36 | 0.37 | 0.36 | 0.37 | 0 |
| (2.5% solution | | | | | | | | | |
| in water) | | | | | | | | | |
| Hydroquinone | 0.0046 | 0.0046 | 0.0051 | 0.0044 | 0.004 | 0.0049 | 0.0045 | 0.0043 | 0 |
| Manganese(II) | 0.13 | 0.13 | 0.09 | 0.09 | 0.10 | 0.08 | 0.09 | 0.09 | 0 |
| acetate tetrahydrate | | | | | | | | | |
| solution 70 mg in | | | | | | | | | |
| 10 mL water | | | | | | | | | |
| Dodecanethiol | 0 | 0 | 0 | 0.01 | 0.02 | 0.04 | 0.06 | 0.1 | 0 |
| 2,2′-Azobis(2- | 0.25 | 0.25 | 0.13 | 0.24 | 0.26 | 0.25 | 0.25 | 0.25 | 0 |
| methylpropion | | | | | | | | | |
| amidine) | | | | | | | | | |
| dihydrochloride | | | | | | | | | |

In this Reference Example 3, weight average molecular weights of some silicone-(meth)acrylate copolymers in Table 4 was measured by GPC as follows: Samples were prepared for GPC by dissolving 174.41 mg of the 29% emulsion copolymer sample described above in Table 4 in 10 mL of THF (5 mg/mL) in a 20 mL vial. The samples were placed on a shaker for 2 h. The sample was then filtered through a 0.45 μm PTFE filter before injecting in the GPC instrument. A Waters e2695 LC pump and autosampler, equipped with two 5 uM Agilent PLG gel Mixed C columns in series and Shodex RI-501 differential refractive index detector was used to analyze the samples. A polystyrene 1683 broad molecular weight standard was used to calibrate the molecular weight range. The instrument was equilibrated for 30 min at 1 mL/min and the samples were also run at 1 mL/min. The results are shown below in Table 5 for the copolymers tested.

TABLE 5
GPC data set:

| Copolymer | | | | | |
|---|---|---|---|---|---|
| Sample | | | | | |
| (Method) | m_n | m_w | m_z | m_p | dispersity |
| 2 (C) | 234,000 | 912,000 | 1,820,000 | 1,090,000 | 3.9 |
| 1 (C) | 232,000 | 721,000 | 1,350,000 | 965,000 | 3.11 |
| 3 (A) | 82,700 | 234,000 | 630,000 | 111,000 | 2.83 |
| 4 (A) | 79,900 | 258,000 | 789,000 | 109,000 | 3.23 |
| 5 (C) | 72,900 | 212,000 | 592,000 | 99,200 | 2.91 |
| 6 (C) | 52,200 | 143,000 | 379,000 | 74,800 | 2.74 |
| 7 (C) | 36,000 | 96,800 | 293,000 | 49,600 | 2.69 |
| 8 (B) | 70,200 | 181,000 | 398,000 | 120,000 | 2.58 |

In this Reference Example 5, the aqueous copolymer emulsions described in Table 4 were used to prepare emulsion formulations, fabrics were treated, and oil repellency was evaluated using the same method described above in Reference Example 2. The emulsion formulations and oil repellency results are shown below in Table 6.

TABLE 6
Emulsion Formulations and Oil Repellency Results

| | Emulsion Formulation | | | | | | | | |
|---|---|---|---|---|---|---|---|---|---|
| Textile | | Copolymer | Additive | Water | | Copolymer | AATCC 118 | | |
| Treatment | | mass | mass (g)- | mass | | MW | 10 | 1 | 5 |
| Example | Copolymer | (g) | XAN | (g) | Fabric | (g/mol) | s | min | min |
| 9 | 1 (C) | 5.75 | 0.69 | 68.56 | PES | 721,000 | A | A | A |
| 10 | 2 (C) | 5.75 | 0.69 | 68.56 | PES | 912,000 | A | A | A |
| 11 | 3 (A) | 5.75 | 0.69 | 68.56 | PES | 234,000 | A | A | B |
| 12 | 4 (A) | 5.75 | 0.69 | 68.56 | PES | 258,000 | A | A | A |
| 13 | 5 (C) | 5.75 | 0.69 | 68.56 | PES | 212,000 | A | B | B |
| 14 | 1 (A) | 6.11 | 0.35 (16:1) | 68.55 | PES | Not measured | A | A | A |
| 15 | 1 (A) | 5.75 | 0.69 (8:1) | 68.56 | PES | Not measured | A | A | A |
| 16 | 1 (A) | 5.17 | 1.25 (4:1) | 68.58 | PES | Not measured | A | A | A |
| 17 | 1 (A) | 4.31 | 2.08 (2:1) | 68.61 | PES | Not measured | A | A | A |
| Comp 8 | 6 (C) | 5.75 | 0.69 | 68.56 | PES | 143,000 | A | B | C |
| Comp 9 | 7 (C) | 5.75 | 0.69 | 68.56 | PES | 96,800 | A | B | D |
| Comp 10 | 8 (B) | 7.66 | 0.93 | 91.41 | PES | 181,000 | A | B | D |

Examples 9-13 and comparative examples 8-10 demonstrate that Mw of the silicone-(meth)acrylate copolymer may impact oil repellency performance. While it is shown that multiple methods (e.g., Methods A to C in Synthesis Examples 1 to 3) can be used to make the silicone-(meth)acrylate copolymer, however, when the Mw of the silicone-(meth)acrylate copolymer was >181,000 g/mol, oil repellency improved under the conditions tested. These results teach away from the disclosure of Progress in Organic Coatings, Lei, H. et al. 2016, which discloses that a molecular weight of 80,000 g/mol for an oil repellency test. Examples 14-17 demonstrate the breadth that the blocked isocyanate additive can be used at (16:1-2:1, copolymer:additive, Additive=XAN in these cases).

In this Synthesis Example 4, PDMS resin 1 (as described in Example 1 of US Patent Publication 20230038369 was prepared as follows: 0.88 g (10 mmol) of 3MT-ALMA, 0.31 g (1 mmol) of vinyl trimethoxysilane and 0.033 g (0.1 mmol) of azobisisobutyronitrile were added to a round bottom flask with 47.95 g of dry xylenes at room temperature. The round bottom flask was equipped with a condenser, nitrogen inlet, overhead stirrer and thermocouple probe. The system was purged with nitrogen for 5 min and then the solution was heated up to 65° C. and then held for 24 h.

In this Synthesis Example 5, PDMS resin 2 was prepared as follows: An 80 DP amino terminated PDMS (30 g, 10 mmol), bisphenol A (2.28 g, 10 mmol) and paraformaldehyde (1.2 g, 40 mmol) were dissolved in 150 mL of chloroform in a 500 mL round bottom flask. The mixture was heated under reflux for 6 h to give a light yellow solution. After removing the solvent under vacuum, the residue was dissolved in 75 mL of methylene chloride. The material was washed with a saturated solution of NaHCO₃ (75 mL×5). The water was then distilled off leaving a light yellow liquid product. PDMS resin 2 gelled by the next day, so this resin could not be coated on a textile.

The procedure for these comparative examples 18 and 19, which included pre-treatment of fabric then treatment with the PDMS resin 1, was as follows: A 1×1 cm PES or Nylon fabric was washed with 200 proof ethanol and then dried in an oven 80° C. for 10 min. Then a silica sol was prepared by hydrolysis of tetraethoxysilane (2.08 g, 10 mmol) in 60 mL of ethanol/15 mL of DI water in the presence of ammonium hydroxide (2.75 mL). The fabric was dipped into the sol for 5 min and dried at room temperature (˜30 min). This process was repeated 2 more times. The fabric was then soaked in a 5% suspension of Ludox HS silica (5 g of a 40% solution of Ludox HS-40 colloidal silica and 35 g of DI water) until saturated (˜4 sec) and then dried overnight at 80° C. The pretreated 1×1 cm PES or nylon fabric samples were dip coated 3 times into PDMS resin 1. The samples were cured for 1 h at 200° C.

The procedure for comparative examples 20 and 21 was as follows: A 1×1 cm PES or nylon fabric sample was dip coated 3 times into synthesis PDMS resin 1. The samples were cured for 1 h at 200° C.

The procedure for comparative examples 22 and 23 was as follows:

A 1×1 cm PES or Nylon fabric was washed with 200 proof ethanol and then dried in an oven 80° C. for 10 min. Then a silica sol was prepared by hydrolysis of tetraethoxysilane (2.08 g, 10 mmol) in 60 mL of ethanol/15 mL of DI water in the presence of ammonium hydroxide (2.75 mL). The fabric was dipped into the sol for 5 min and dried at room temperature (˜30 min). This process was repeated 2 more times. The fabric was then soaked in a 5% suspension of Ludox HS silica (5 g of a 40% solution of Ludox HS-40 colloidal silica and 35 g of DI water) until saturated (˜4 sec) and then dried overnight at 80° C.

TABLE 7
Results for Comparative Examples 18 to 23

AATCC 118 Oil Repellency

| Example | Fabric type | 10 s | 5 min |
|---|---|---|---|
| Comp 18 | PES | A | C |
| Comp 19 | Nylon | A | C |
| Comp 20 | PES | B | C |
| Comp 21 | Nylon | B | D |
| Comp 22 | PES | D | Not measured |
| Comp 23 | Nylon | D | Not measured |

Comp 18 and Comp 19 correspond to example 2 disclosed in US Patent Publication US20230038369. These received a failing oil repellency grade after 5 min in the modified AATCC method 118. In contrast, the present invention, (e.g., as shown in examples 1 and 5 in Table 3, above) had superior oil repellency using the AATCC method 118. Comp 20 and Comp 21 removed the sol gel and nanoparticle treatment and tested the 3MT-ALMA/vinyl trimethoxysilane copolymer, and these examples also failed the modified AATCC method 118 after 5 min.

In this Comparative Example 24 (Comp 24) the PES fabric was treated with 2 separate emulsions in 2 separate steps. First the fabric was coated with an emulsion of Phobol-XAN (0.69 g XAN+74.31 g DI water), described in the coating/curing methods in Reference Example 2, above. In a second step the fabric was treated with an emulsion of copolymer 1 from Table 2, above, in which 5.75 g of the Copolymer Emulsion 1 from Table 2 was combined with 69.25 g DI water using the same coating and curing methods described above in Reference Example 2.

Comparative example 24 shows a pretreatment method of the blocked isocyanate (XAN) additive similarly described in example 2 in US Patent Publication US20230038369 (Comp 18 and Comp 19 above). This comparative example 24 did not pass the modified AATCC method 118 after 10 sec and had worse oil repellency than Comp 18 and Comp 19 at 10 sec.

In this Comparative Example 25, 3.83 g of Copolymer Emulsion 1 described above in Table 2 and 1.59 g of DOWSIL™ IE-8749, a 70% solids silicone durable water repellent that is commercially available from The Dow Chemical Company, were added into a 125 g Nalgene plastic bottle. The bottle was then inverted twice to mix the contents. Fabric was coated and oil repellency was measured as described above in Reference Example 2. The fabric had a C rating after 10 s and a D rating after 30 s. Comparative 25 showed that a silicone material (the active in IE-8749) blended with a copolymer of 3MT-ALMA failed the oil repellency test herein after 30 s.

In this Reference Example 6, a study of blocked isocyanates described below in Table 8 was performed as follows. Textile treatment emulsions were prepared as follows. Each starting material in the amounts as listed in Table 9 were added into a 125 g Nalgene plastic bottle. After adding the bottle was inverted twice to mix the contents. Order of addition was not important. In this Reference Example 6, fabrics were treated with the textile treatment emulsions prepared as described above. All the fabrics were washed and dried before coating. The textile treatment emulsion as described below in Table 9 was then poured into beaker and then dip coated and passed through a Werner Mathis AG Textilmaschinen padder (tension setting of 70) for coating. After passing through once, the sample was in a forced air Mathis LTF oven at 160° C. for 3_min. The samples were evaluated for oil repellency using the method described above in Reference Example 2. The results are shown below in Table 10.

TABLE 8
Commercially Available Blocked Isocyanate Dispersions (Additives)

| Name | Description | Source |
|---|---|---|
| PHOBOL ™ | aqueous dispersion comprising 5 - 30% aliphatic | Archroma |
| EXTENDER | isocyanate (HDI) blocked with 3,5- | |
| UXN | dimethylpyrazole. PHOBOL ™ EXTENDER UXN | |
| | may be free of butanone oxime | |
| PHOBOL ™ | aqueous dispersion comprising 5 - 30% phenyl | Archroma |
| EXTENDER | blocked with butanone oxime. PHOBOL ™ | |
| XAN | EXTENDER UAN may be free of butanone oxime | |
| Imprafix ™ AH | 39% blocked isocyanate dispersion, water based | Covestro AG of |
| | cosolvent-free blocked aliphatic isocyanate; contains | Germany |
| | 3,5-dimethyl-1H-pyrazole and dimethylethanolamine | |
| | and deblocks at a temperature of 130° C. for 2 | |
| | minutes, see US20210354203 paragraph [0043] | |
| BAYBOND ™ XL | 30% blocked isocyanate dispersion, caprolactam | Covestro |
| 7270 | blocked HDI solids in water, with deblocking | |
| | temperature of 170 to 190° C., see WO2022182360 | |
| | paragraph [0099] | |
| BAYBOND ™ XL | 30% blocked aliphatic isocyanate in a waterbased | Covestro |
| 3674 | dispersion, caprolactam blocked HDI 20% solids in | |
| | water, with deblocking temperature from 170 to 190 | |
| | C. see WO2022182360 paragraph [0099]. This | |
| | product may contain an anionic surfactant. | |
| Permuthane ™ | DMP blocked isocyanate dispersion containing SiH | Stahl Holdings B.V. |
| XR-9163 | functional silicone | |
| Permutex ™ XR | Very high reactive DMP blocked isocyanate in a | Stahl, see Highest |
| 22-903 | dispersion that also contains diethanolamine | performance in tailor- |
| | | made Coated Fabrics \| |
| | | Stahl \| Stahl |
| NK Assist NY11 | Aliphatic type blocked isocyanate dispersion | Nicca Chemical Co |
| NK Assist FU | Aqueous mixture containing water, MEK and EO/PO | Nicca Chemical Co |
| | similar to NK Assist NY11. There is a butanonoxime | |
| | structure present, with stereoisomers. The oxime is | |
| | correlated to TDI. There is still EO-PO polyol in high | |
| | abundance. Another major component was isocyanate | |
| | crosslinking via 2-ethyl-2-(hydroxymethyl)-1,3- | |
| | propanediol and extending the EO-PO polyol. | |
| Imprafix ™ 2794-1 | Block aliphatic polyisocyanate, blocked iwth 1H- | Covestro |
| | Pyrazole, 3,5-dimethyl in a dispersion that contains | |
| | dimethanolamine | |
| RUCO ™-LINK | Blocked aliphatic isocyanate | Rudolph Group |
| XCR | | |

TABLE 9
Emulsion Formulations Prepared According
to Reference Example 6

| | Co-polymer | | | | Additive |
|---|---|---|---|---|---|
| | (from Table | Copolymer | Additive | Water | from |
| Sample | 2, above) | mass (g) | mass (g) | mass (g) | Table 8 |
| 6-1 | 1 | 7.66 | 0.93 | 91.41 | XAN |
| 6-2 | 1 | 5.75 | 0.35 | 68.91 | UXN |
| 6-3 | 1 | 5.75 | 0.69 | 68.56 | UXN |
| 6-4 | 1 | 5.75 | 1.04 | 68.21 | UXN |
| 6-5 | 1 | 5.75 | 1.39 | 67.86 | UXN |
| 6-6 | 1 | 5.75 | 2.78 | 66.48 | UXN |
| 6-7 | 1 | 5.75 | 5.56 | 63.70 | UXN |
| 6-8 | 1 | 5.75 | 0.31 | 68.94 | NY11 |
| 6-9 | 1 | 5.75 | 2.38 | 66.87 | NY11 |
| 6-10 | 1 | 5.75 | 0.27 | 68.98 | FU |
| 6-11 | 1 | 5.75 | 2.08 | 67.17 | FU |
| 6-12 | 1 | 5.75 | 0.27 | 68.98 | 2794 |
| 6-13 | 1 | 5.75 | 2.08 | 67.17 | 2794 |
| 6-14 | 1 | 5.75 | 0.27 | 68.98 | AH |
| 6-15 | 1 | 5.75 | 2.08 | 67.17 | AH |
| 6-16 | 1 | 5.75 | 0.52 | 68.74 | 9163 |
| 6-17 | 1 | 5.75 | 3.97 | 65.28 | 9163 |
| 6-18 | 1 | 5.75 | 0.27 | 68.98 | 22-903 |
| 6-19 | 1 | 5.75 | 2.08 | 67.17 | 22-903 |
| 6-20 | 1 | 5.75 | 0.36 | 68.89 | 3674 |
| 6-21 | 1 | 5.75 | 2.78 | 66.48 | 3674 |
| 6-22 | 1 | 5.75 | 0.36 | 68.89 | 7270 |
| 6-23 | 1 | 5.75 | 2.78 | 66.48 | 7270 |
| 6-24 | 1 | 5.75 | 0.49 | 68.76 | XCR |
| 6-25 | 1 | 5.75 | 0.95 | 68.31 | XCR |
| 6-26 | 1 | 5.75 | 1.42 | 67.83 | XCR |
| 6-27 | 1 | 5.75 | 1.89 | 67.36 | XCR |
| 6-28 | 1 | 5.75 | 3.79 | 65.46 | XCR |
| 6-29 | 1 | 5.75 | 7.58 | 61.68 | XCR |

TABLE 10
AATCC Test Results of the Samples in Table 9

| | | | | AATCC 118 | | | | |
|---|---|---|---|---|---|---|---|---|
| | Fabric | | Ratio of | 0 | 10 | 30 | 1 | 5 |
| Example | type | Additive | Copolymer:Additive | s | s | s | min | min |
| 6-1 | PES | XAN | 8:1 | A | A | A | A | A |
| 6-2 | PES | UXN | 16:1 | A | A | A | A | A |
| 6-3 | PES | UXN | 8:1 | A | A | A | A | A |
| 6-4 | PES | UXN | 6:1 | A | A | A | A | A |
| 6-5 | PES | UXN | 4:1 | A | A | A | A | A |
| 6-6 | PES | UXN | 2:1 | A | A | A | A | A |
| 6-7 | PES | UXN | 1:1 | A | A | A | A | A |
| 6-8 | PES | NY11 | 16:1 | A | B | C | C | D |
| 6-9 | PES | NY11 | 2:1 | A | B | B | C | D |
| 6-10 | PES | FU | 16:1 | A | B | C | C | D |
| 6-11 | PES | FU | 2:1 | A | B | C | C | D |
| 6-12 | PES | 2794 | 16:1 | A | B | C | C | D |
| 6-13 | PES | 2794 | 2:1 | A | B | B | C | D |
| 6-14 | PES | AH | 16:1 | A | B | C | C | D |
| 6-15 | PES | AH | 2:1 | A | B | B | C | D |
| 6-16 | PES | 9163 | 16:1 | C | C | D | — | — |
| 6-17 | PES | 9163 | 2:1 | B | C | D | — | — |
| 6-18 | PES | 22-903 | 16:1 | A | B | C | C | D |
| 6-19 | PES | 22-903 | 2:1 | A | B | B | C | D |
| 6-20 | PES | 3674 | 16:1 | A | B | C | D | |
| 6-21 | PES | 3674 | 2:1 | A | B | B | C | D |
| 6-22 | PES | 7270 | 16:1 | A | B | C | D | |
| 6-23 | PES | 7270 | 2:1 | A | B | C | C | D |
| 6-24 | PES | XCR | 16:1 | A | A | A | A | A |
| 6-25 | PES | XCR | 8:1 | A | A | A | A | A |
| 6-26 | PES | XCR | 6:1 | A | A | A | A | A |
| 6-27 | PES | XCR | 4:1 | A | A | A | A | A |
| 6-28 | PES | XCR | 2:1 | A | A | A | A | B |
| 6-29 | PES | XCR | 1:1 | A | A | A | B | D |

Without wishing to be bound by theory, it is thought that the additive may be free of species that may interfere with the performance of the isocyanate in the emulsion formulation, such as silicones and amines (that are not within the blocking group). And, without wishing to be bound by theory, it is thought that the blocked isocyanate may be delivered in an emulsion or dispersion that is free of anionic surfactant.

In this Comparative Example 26, 2.25 g of Daikin XF-5100 (available in the United States instead of XF-5003, 3%), 4.5 g of RUCODRY Eco Plus (6%) and 1.875 g of RUCO-LINK XCR (2.5%) (both from Rudolf Group) with 66.125 g of water. The resulting sample was coated on PES and evaluated via the modified AATCC 118 test in Reference Example 2. The treated fabric failed the oil repellency test at 30 sec.

### INDUSTRIAL APPLICABILITY

The above examples show that the emulsion formulation and process described herein can produce a fabric having durable oil repellency. As used herein, “oil repellency” means an A or B face ranking after a large oil drop contacts the textile for 5 minutes, as measured by the modified AATCC 118 test described above. As used here “durable” means that the textile can be washed at least 5 times after treatment with the emulsion formulation as described herein, and the fabric will still have oil repellency as described above (as shown above in Example 7).

The inventors surprisingly found that including the blocked isocyanate in the emulsion formulation improved oil repellency of textiles treated with the emulsion formulation as compared to fabrics treated with a comparative composition that did not contain the blocked isocyanate (see Example 1 and Comparative Example 2; and Example 2 and Comparative Example 3, above). This finding is particularly unexpected when the starting materials copolymerized in the method described above, and the resulting silicone-(meth)acrylate copolymer, were free of crosslinkable groups. Furthermore, the inventors surprisingly found that the emulsion formulation imparted durable oil repellency to textiles even when the fabric was not pre-treated, e.g., with plasma treatment or washing before coating the textile with the emulsion formulation.

### Definitions and Usage of Terms

All amounts, ratios, and percentages herein are by weight, unless otherwise indicated. The SUMMARY and ABSTRACT are hereby incorporated by reference. The articles, “a”, “an”, and “the” each refer to one or more, unless otherwise indicated by the context of the specification. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The symbol “<” denotes “less than”, the symbol “>” denotes “greater than”, the symbol “≤” denotes “less than or equal to”, and the symbol “≥” denotes “greater than or equal to”. The abbreviations used herein have the definitions in Table 11.

TABLE 11
Abbreviations

| Abbreviation | Definition |
|---|---|
| AATCC | American Association of Textile Chemists and Colorists |
| ° C. | degrees Celsius |
| Comp | comparative |
| DP | Degree of polymerization |
| ° F. | degrees Fahrenheit |
| GPC | Gel permeation chromatography |
| g | grams |
| h | hour |
| H₆XDI | 1,4-bis-(isocyanatomethyl)-cyclohexane |
| H₁₂MDI | Bis(4-isocyanatocyclohexyl)methane |
| HDI | 1,6-diisocyanatohexane |
| IPDI | 1-isocyanato-3-isocyanatomethyl-3,5,5-trimethylcyclohexane |
| m | meters |
| MDI | Bis(4-isocyanatophenyl)methane |
| (meth)acrylate | class of compound including an acrylate, a methacrylate, or both. |
| min | minutes |
| mL | milliliters |
| N-heterocycle | nitrogen containing heterocycle |
| PDMS | polydimethylsiloxane |
| ppm | Parts per million |
| psi | pounds per square inch |
| PTFE | polytetrafluoroethylene |
| RT | room temperature of 25° C. ± 2° C. |
| TDI | 2,4-diisocyanato-1-methylbenzene |
| THF | tetrahydrofuran |
| TMI | 1-(isocyanato-1-methylethyl)-3-(1-methyl-1-ethenyl)benzene |
| TMXDI | 1,3-bis(1-isocyanato-1-methylethyl)-benzene |
| uL | microliter |
| um | micrometer |
| XDI | 1,4-bis(isocyanatomethyl)benzene |

1. A method for preparing an emulsion formulation suitable for treating a textile, wherein the method comprises:
1) copolymerizing starting materials comprising
(A) a silicone-(meth)acrylate macromonomer of formula 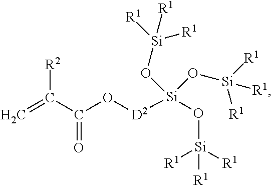
where each R¹ is an independently selected monovalent hydrocarbon group of 1 to 12 carbon atoms; D² is a divalent hydrocarbon group of 2 to 12 carbon atoms; and R² is selected from the group consisting of H and methyl;
optionally (B) a silicone-(meth)acrylate co-macromonomer, wherein (B) the silicone-(meth)acrylate co-macromonomer has a formula selected from the group consisting of formula (B-1), formula (B-2), and a combination of both formula (B-1) and formula (B-2), wherein
formula (B-1) is 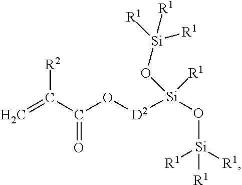
where each R¹ is an independently selected monovalent hydrocarbon group of 1 to 12 carbon atoms; D² is a divalent hydrocarbon group of 2 to 12 carbon atoms; and R² is selected from the group consisting of H and methyl;
formula (B-2) is 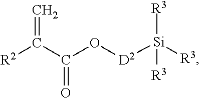
where R² is selected from the group consisting of H and methyl; D² is a divalent hydrocarbon group of 2 to 12 carbon atoms, and each R³ is a group of formula OSi(R⁴)₃; where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon group of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ are selected such that the silicone-(meth)acrylate co-macromonomer of formula (B-2) has at least 5 silicon atoms per molecule;
where starting material (A) is present in an amount of >25 weight % to 100 weight %, based on combined weights of starting materials (A) and (B); and
where starting material (B) is present in an amount of 0 to <75 weight %, based on combined weights of starting materials (A) and (B); and
where starting materials (A) and (B) are copolymerized in the presence of an additional starting material, wherein the additional starting material comprises
(C) an initiator;
optionally (H) a chain transfer agent;
optionally (I) a manganese ion source; and
optionally (J) a phenolic compound; and
where one of conditions (i) or (ii) is met,
where condition (i) is that step 1) further comprises adding a solvent before or during step 1), removing the solvent after forming (F) the silicone-(meth)acrylate copolymer, and forming an aqueous emulsion comprising (F) the silicone-(meth)acrylate copolymer, (D) a surfactant, and (E) water; and
where condition (ii) is that step 1) comprises an emulsion polymerization reaction; the additional starting materials further comprise (D) a surfactant and (E) water; and
where the product of step 1) comprises an aqueous emulsion comprising (F) the silicone-(meth)acrylate copolymer, (D) the surfactant, and (E) the water; and where (E) the silicone-(meth)acrylate copolymer is a reaction product of starting material consisting essentially of (A) the silicone-(meth)acrylate macromonomer and (C) the initiator, and when present (B) the silicone-(meth)acrylate co-macromonomer and/or (H) the chain transfer agent;
2) combining materials comprising the aqueous emulsion and (G) a blocked isocyanate, and optionally an additional starting material, where the additional starting material, when present, is selected from the group consisting of (K) a biocide, (L) additional water, (M) a flame retardant, (N) a wrinkle reducing agent, (O) an antistatic agent, (P) a penetrating agent, (Q) a softening agent, and a combination of two or more thereof.

2. The method of claim 1, where
each R¹ is methyl,
each R² is methyl,
each D² is propylene,
each R³ is the group of formula OSi(R⁴)₃; where
each R⁴ is independently selected from the group consisting of R and OSi(R⁵)₃, where
each R is methyl;
each R⁵ is independently selected from the group consisting of R and OSi(R⁶)₃; where
each R⁶ is independently selected from the group consisting of R and OSiR₃;
with the proviso that R⁴, R⁵, and R⁶ are selected such that the silicone-(meth)acrylate co-macromonomer of formula (B-2) has 10 to 16 silicon atoms per molecule.

3. The method of claim 1, where starting material (A) is 3-(1,1,1,5,5,5-hexamethyl-3-((trimethylsilyl)oxy)trisiloxan-3-yl) propyl methacrylate.

4. The method of claim 1, where (B) the silicone-(meth)acrylate co-macromonomer of formula (B-1) is present in an amount of 1 weight % to 50 weight %, based on combined weights of starting materials (A) and (B), and formula (B-1) is 3-(1,1,1,3,5,5,5-heptamethyltrisiloxan-3-yl) propyl methacrylate.

5. The method of claim 1, where (B) the silicone-(meth)acrylate co-macromonomer of formula (B-2) is present is present in an amount of 1 weight % to 50 weight %, based on combined weights of starting materials (A) and (B), and formula (B-2) is selected from the group consisting of 3-(5-((1,1,1,3,5,5,5-heptamethyltrisiloxan-3-yl)oxy)-1,1,1,3,7,9,9,9-octamethyl-3,7-bis((trimethylsilyl)oxy)pentasiloxan-5-yl) propyl methacrylate;
3-(1,5-bis(2-(1,1,1,5,5,5-hexamethyl-3-((trimethylsilyl)oxy)trisiloxan-3-yl)ethyl)-3-(((2-(1,1,1,5,5,5-hexamethyl-3-((trimethylsilyl)oxy)trisiloxan-3-yl)ethyl)dimethylsilyl)oxy)-1,1,5,5-tetramethyltrisiloxan-3-yl) propyl methacrylate; and a combination thereof.

6. The method of claim 1, where (C) the initiator comprises: 2,2′-Azobis(2-methylpropionamidine)dihydrochloride.

7. The method of claim 1, where (D) the surfactant is selected from the group consisting of a cationic surfactant, a nonionic surfactant, and a combination thereof.

8. The method of claim 1, where (H) the chain transfer agent is present, and the chain transfer agent comprises dodecane thiol.

9. The method of claim 1, where (I) the manganese ion source is present, and the manganese ion source comprises manganese (II) acetate, manganese (II) acetate tetrahydrate, or a combination thereof.

10. The method of claim 1, where the phenolic compound is present, and the phenolic compound is selected from the group consisting of hydroquinone, monomethyl ether of hydroquinone, tert-butylhydroquinone, and a combination of two or more thereof.

11. The method of claim 1, where (G) the blocked isocyanate comprises an oxime blocked isocyanate.

12. A textile treatment emulsion prepared by the method of claim 1, where the textile treatment emulsion comprises:
(F) the silicone-(meth)acrylate copolymer, wherein the silicone-(meth)acrylate copolymer comprises unit formula: 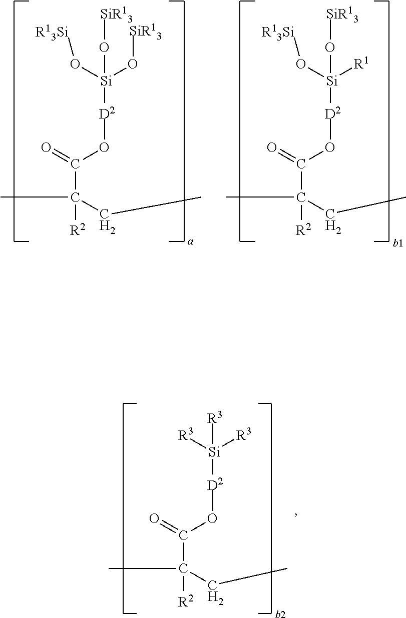
where
each R¹ is an independently selected monovalent hydrocarbon group of 1 to 12 carbon atoms;
each D² is independently a divalent hydrocarbon group of 2 to 12 carbon atoms; and
each R² is independently selected from the group consisting of H and methyl;
each R³ is a group of formula OSi(R⁴)₃; where
each R⁴ is independently selected from the group consisting of R and DSi(R⁵)₃, where each R is an independently selected monovalent hydrocarbon group of 1 to 12 carbon atoms, and
each D is independently selected from the group consisting of an oxygen atom, a (poly)alkylene oxide group of 1 to 12 units, and a divalent hydrocarbon group of 2 to 4 carbon atoms;
each R⁵ is independently selected from the group consisting of R and DSi(R⁶)₃; where
each R⁶ is independently selected from the group consisting of R and DSiR₃;
with the proviso that R⁴, R⁵, and R⁶ are selected such that the silicone-(meth)acrylate co-macromonomer unit with subscript b2 has at least 5 silicon atoms;
subscripts a, b1, and b2 represent weight fractions of units in the copolymer, and subscripts a, b1, and b2 have values such that
$$0.25 < a \leq 1 ; and$$
$$0 \leq ( b 1 + b 2 ) < 0 \text{.75} ;$$
and
the silicone-(meth)acrylate copolymer further comprises a terminal moiety;
(D) the surfactant;
(E) the water; and
(G) the blocked isocyanate.

13. The textile treatment emulsion of claim 12, where the textile treatment emulsion is fluorocarbon-free.

14. A method for treating a textile, wherein the method comprises:
I) coating the textile with the emulsion formulation of claim 12; and
II) heating the textile.

15. A composition comprising:
(F) a silicone-(meth)acrylate copolymer comprising unit formula: 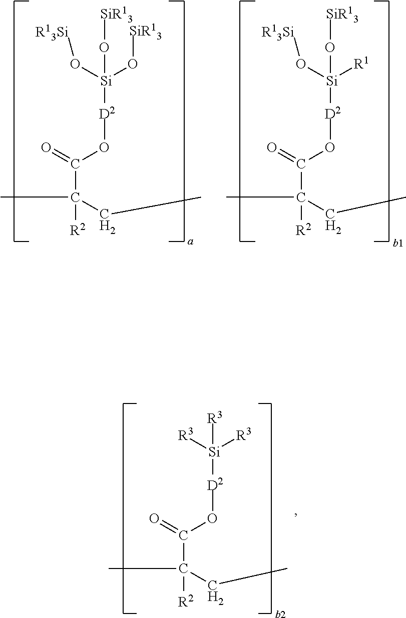
where
each R¹ is an independently selected monovalent hydrocarbon group of 1 to 12 carbon atoms;
each D² is independently a divalent hydrocarbon group of 2 to 12 carbon atoms;
each R² is independently selected from the group consisting of H and methyl;
each R³ is a group of formula OSi(R⁴)₃; where
each R⁴ is independently selected from the group consisting of R and DSi(R⁵)₃, where
each R is an independently selected monovalent hydrocarbon group of 1 to 12 carbon atoms, and
each D is independently selected from the group consisting of an oxygen atom, a (poly)alkylene oxide group of 1 to 12 units, and a divalent hydrocarbon group of 2 to 4 carbon atoms;
each R⁵ is independently selected from the group consisting of R and DSi(R⁶)₃; where
each R⁶ is independently selected from the group consisting of R and DSiR₃;
with the proviso that R⁴, R⁵, and R⁶ are selected such that the silicone-(meth)acrylate co-macromonomer unit with subscript b2 has at least 5 silicon atoms;
subscripts a, b1, and b2 represent weight fractions of units in the copolymer, and subscripts a, b1, and b2 have values such that
$$0.25 < a \leq 1 ; and$$
$$0 \leq ( b 1 + b 2 ) < 0 \text{.75} ;$$
(I) a manganese ion source; and
(J) a phenolic compound; wherein the composition is prepared by a method comprising
1) copolymerizing starting materials comprising
(A) a silicone-(meth)acrylate macromonomer of formula 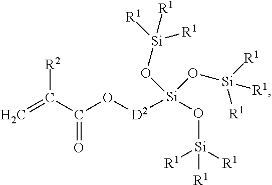
where each R¹ is an independently selected monovalent hydrocarbon group of 1 to 12 carbon atoms; D² is a divalent hydrocarbon group of 2 to 12 carbon atoms; and R² is selected from the group consisting of H and methyl;
optionally (B) a silicone-(meth)acrylate co-macromonomer, wherein (B) the silicone-(meth)acrylate co-macromonomer has a formula selected from the group consisting of formula (B-1), formula (B-2), and a combination of both formula (B-1) and formula (B-2), wherein
formula (B-1) is 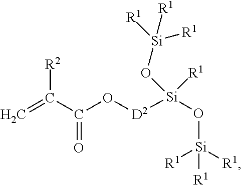
where each R¹ is an independently selected monovalent hydrocarbon group of 1 to 12 carbon atoms; D² is a divalent hydrocarbon group of 2 to 12 carbon atoms; and R² is selected from the group consisting of H and methyl;
formula (B-2) is 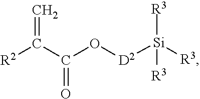
where R² is selected from the group consisting of H and methyl; D² is a divalent hydrocarbon group of 2 to 12 carbon atoms, and each R³ group of formula OSi(R⁴), where each R⁴ is independently selected from the group consisting of R and DSi(R⁵)₃, where each R is an independently selected monovalent hydrocarbon group of 1 to 12 carbon atoms, and each D is independently selected from the group consisting of an oxygen atom, a (poly)alkylene oxide group of 1 to 12 units, and a divalent hydrocarbon g ap of 2 to 4 carbon atoms; each R⁵ is independently selected from the group consisting of R and DSi(R⁶)₃; where each R⁶ is independently selected from the group consisting of R and DSiR₃; with the proviso that R⁴, R⁵, and R⁶ elected such that the silicone-(meth)acrylate co-macromonomer of formula (B-2) has at least 5 silicon atoms per molecule;
where starting material (A) is present in an amount of >25 weight % to 100 weight %, based on combined weights of starting material (A) and (B); and
where starting material (B) is present in an amount of 0 to <75 weight %, based on combined weights of starting materials (A) and (B); and
where starting materials (A) and (B) are copolymerized in the presence of an additional starting material, wherein the additional starting material comprises
(C) an initiator;
optionally (H) a chain transfer agent;
(I) a manganese ion source, and
(J) a phenolic compound; and
where one of conditions (i) or (ii) is met,
where condition (i) is that step 1) further comprises adding a solvent before or during step 1), removing the solvent after forming (F) the silicone-(meth)acrylate copolymer, and forming an aqueous emulsion comprising (F) the silicone-(meth)acrylate copolymer, (D) a surfactant, and (E) water; and
where condition (ii) is that step 1) comprises an emulsion polymerization reaction; the additional starting materials further comprise (D) a surfactant and (E) water; and
where the product of step 1) comprises an aqueous emulsion comprising (F) the silicone-(meth)acrylate copolymer, (D) the surfactant, and (E) the water, and where (F) the silicone-(meth)acrylate copolymer is a reaction product of starting materials consisting essentially of (A) the silicone-(meth)acrylate macromonomer and (C) the initiator, and when present (B) the silicone-(meth)acrylate co-macromonomer and/or (H) the chain transfer agent.

16.-20. (canceled)
